(19) United States
(12) Patent Application Publication
(10) Pub. No.: US 2026/0010948 A1
(43) Pub. Date: Jan. 8, 2026

(54) SYSTEMS AND METHODS FOR FINANCIAL RISK ASSESSMENT AND DIGITAL SECURITY ENHANCEMENT

(71) Applicant: Closerly Inc., Plympton Wyoming (CA)

(72) Inventors: Adrian Mag, Windsor (CA); Jim Angelidis, Plympton-Wyoming (CA)

(21) Appl. No.: 19/259,145

(22) Filed: Jul. 3, 2025

Related U.S. Application Data
(60) Provisional application No. 63/667,457, filed on Jul. 3, 2024.

(51) Int. Cl. G06Q 40/03; G06Q 40/06

(52) U.S. Cl. CPC G06Q 40/033; G06Q 40/06

(57) ABSTRACT

Provided are methods, systems, and devices for financial risk assessment and digital security enhancement. This includes receiving, at the host processor via the computing network, a plurality of input signals from a plurality of primary systems, the input signals corresponding to a client identifier to generate a corresponding first record; analyzing the corresponding first record, to extract a corresponding second record by implementing a plurality of predefined tags and generating a categorized record; receiving physical asset signals, associated to the client identifier, from an external asset system; generating a qualifier score based on a predictive algorithm applied to the categorized record and the physical asset signals, the predictive algorithm assigning weights to the plurality of data categories in the categorized record; and determining whether the qualifier score meets a one or more threshold range.

### CROSS-REFERENCE TO RELATED APPLICATIONS

This application claims priority from U.S. provisional application No. 63/667,457, filed Jul. 3, 2024, the contents of which are hereby incorporated herein by reference.

### FIELD

The embodiments described herein generally relate to systems and methods for digital security enhancement and financial risk assessment and, in particular, to periodic and continuous financial data extraction, risk assessment, and score qualification.

### BACKGROUND

The following is not an admission that anything discussed below is part of the prior art or part of the common general knowledge of a person skilled in the art.

Existing computer systems for financial risk assessment, especially for tenancy or mortgage qualifications, involve filling out extensive forms and data entries. These traditional systems typically rely on a single point-in-time data check, which often leads to inaccuracies as the data may become outdated by the time a mortgage or tenancy decision is made. Moreover, these processes are computationally inefficient, requiring manual intervention and the use of physical documentation, consuming unnecessary processing power and time. Furthermore, the forms can be forged, and fraudulent data may be submitted in mortgage or tenancy applications. Accordingly, there is a need for alternative systems and methods that can address the inefficiencies of the conventional systems.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least one embodiment, there is provided a computer-implemented method, performed by a host processor via a computing network. The method includes receiving, at the host processor via the computing network, a plurality of input signals from a plurality of external systems, the input signals corresponding to a client identifier to generate a corresponding first record, and the external systems including primary systems and one or more secondary systems; analyzing, at the host processor, the corresponding first record, to extract a corresponding second record by implementing a plurality of predefined tags, the corresponding second record including a plurality of primary signals received from the primary systems and a plurality of secondary signals received from the one or more secondary systems; verifying, at the host processor, the corresponding second record by comparing a primary signal subset from the plurality of primary signals to a secondary signal subset from the plurality of secondary signals, to generate a verified signal when matched; on receiving a verified signal, segregating, at the host processor, the plurality of primary signals to generate a categorized record including a plurality of data categories, wherein a data category corresponds to a predefined tag; receiving, at the host processor via the computing network, physical asset signals, associated to the client identifier, from an external asset system; generating, at the host processor, a qualifier score based on a predictive algorithm applied to the categorized record and the physical asset signals, the predictive algorithm assigning weights to the plurality of data categories in the categorized record; and determining whether the qualifier score meets a one or more threshold range.

In one or more embodiments, the method may further include normalizing, at the host processor, the plurality of data categories based on a sufficiency factor, wherein the sufficiency factor provides completeness check on the plurality of data categories by comparing the plurality of data categories to a plurality of weighted fields to determine a missing data value; on determining the missing data value, when a corresponding data value is available in the plurality of secondary signals, entering the corresponding data value from the plurality of secondary signals to the missing data value in the plurality of data categories; and on determining the missing data value, when the corresponding data value is unavailable in the plurality of secondary signals, entering a null value to the missing data value in the plurality of data categories.

In one or more embodiments, the plurality of external systems may include employment data server, financial institution server, credit reporting server, estate servers, criminal records server, and client data servers.

In one or more embodiments, the implementing of the predefined tags may further include scanning, by the host processor, the input signals to extract an identified information matching the predefined tags; and storing the identified information in the corresponding second record.

In one or more embodiments, the predefined tags may include an asset tag, a liability tag, and a transactions tag.

In one or more embodiments, the plurality of data categories may include an asset category, a liability category, and an income category.

In one or more embodiments, the physical asset signals may include any one or more of a location data, an asset market value, a transaction date, and a rental value.

In one or more embodiments, the plurality of input signals can be received from a plurality of external systems by a secure application programming interface (API).

In one or more embodiments, the plurality of input signals can be received as a JSON file.

In another aspect, in at least one embodiment, there is provided a score estimation device for connected to a computing network. The score estimation device comprises a signal reception module, configured to receive, by the computing network, a plurality of input signals from a plurality of external systems, the input signals corresponding to a client identifier to generate a corresponding first record, and the external systems including primary systems and one or more secondary systems; a data extraction module, configured to extract a corresponding second record by implementing a plurality of predefined tags, the corresponding second record including a plurality of primary signals received from the primary systems and a plurality of secondary signals received from the one or more secondary systems; a data verification module, configured to verify the corresponding second record by comparing a primary signal subset from the plurality of primary signals to a secondary signal subset from the plurality of secondary signals, to generate a verified signal when matched; a data segregation module, configured to, on receiving the verified signal, segregate the plurality of primary signals to generate a categorized record including a plurality of data categories, wherein a data category corresponds to a predefined tag; the signal reception module, configured to receive, by the computing network, physical asset signals, associated to the client identifier, from an external asset system; a score calculation module, configured to generate, a qualifier score based on a predictive algorithm applied to the categorized record and the physical asset signals, the predictive algorithm assigning weights to the plurality of data categories in the categorized record; and a threshold determination module, configured to determine whether the qualifier score meets a one or more threshold range.

In one or more embodiments, the normalization module is further configured to normalize, at the host processor, the plurality of data categories based on a sufficiency factor, wherein the sufficiency factor provides completeness check on the plurality of data categories by comparing the plurality of data categories to a plurality of weighted fields to determine a missing data value; on determining the missing data value, when a corresponding data value is available in the plurality of secondary signals, entering the corresponding data value from the plurality of secondary signals to the missing data value in the plurality of data categories; and on determining the missing data value, when the corresponding data value is unavailable in the plurality of secondary signals, entering a null value to the missing data value in the plurality of data categories.

In one or more embodiments, the data extraction module is further configured to scan the input signals to extract an identified information matching the predefined tags; and store the identified information in the corresponding second record.

In another aspect, in at least one embodiment, there is provided a computer-readable storage medium, storing computer-executable instructions thereon, when executed by a computer, the computer is configured to receive, at the host processor via the computing network, a plurality of input signals from a plurality of external systems, the input signals corresponding to a client identifier to generate a corresponding first record, and the external systems including primary systems and one or more secondary systems; analyze, at the host processor, the corresponding first record, to extract a corresponding second record by implementing a plurality of predefined tags, the corresponding second record including a plurality of primary signals received from the primary systems and a plurality of secondary signals received from the one or more secondary systems; verify, at the host processor, the corresponding second record by comparing a primary signal subset from the plurality of primary signals to a secondary signal subset from the plurality of secondary signals, to generate a verified signal when matched; on receiving a verified signal, segregate, at the host processor, the plurality of primary signals to generate a categorized record including a plurality of data categories, wherein a data category corresponds to a predefined tag; receive, at the host processor, physical asset signals, associated to the client identifier, from an external asset system; generate, at the host processor, a qualifier score based on a predictive algorithm applied to the categorized record and the physical asset signals, the predictive algorithm assigning weights to the plurality of data categories in the categorized record; and determine whether the qualifier score meets a one or more threshold range.

In another aspect, in at least one embodiment, there is provided a computer-implemented method, performed by a host processor via a computing network. The method comprises receiving, at the host processor via the computing network, a plurality of input signals from a plurality of primary systems, the input signals corresponding to a client identifier to generate a corresponding first record; analyzing, at the host processor, the corresponding first record, to extract a corresponding second record by implementing a plurality of predefined tags and generating a categorized record from the corresponding second record, the categorized record including a plurality of data categories, wherein a data category corresponds to a predefined tag; receiving, at the host processor via the computing network, physical asset signals, associated to the client identifier, from an external asset system; generating, at the host processor, a qualifier score based on a predictive algorithm applied to the categorized record and the physical asset signals, the predictive algorithm assigning weights to the plurality of data categories in the categorized record; and determining whether the qualifier score meets a one or more threshold range.

In one or more embodiments, the method may further includes normalizing, at the host processor, the plurality of data categories based on a sufficiency factor, wherein the sufficiency factor provides completeness check on the plurality of data categories by comparing the plurality of data categories to a plurality of weighted fields to determine a missing data value; and on determining the missing data value, entering a null value to the missing data value in the plurality of data categories.

In another aspect, in at least one embodiment, there is provided a score estimation device for connected to a computing network. The device comprises a signal reception module, configured to receive, by the computing network, a plurality of input signals from a plurality of primary systems, the input signals corresponding to a client identifier to generate a corresponding first record; a data extraction module, configured to extract a corresponding second record by implementing a plurality of predefined tags and generating a categorized record from the corresponding second record, the categorized record including a plurality of data categories, wherein a data category corresponds to a predefined tag; the signal reception module, configured to receive, by the computing network, physical asset signals, associated to the client identifier, from an external asset system; a score calculation module, configured to generate, a qualifier score based on a predictive algorithm applied to the categorized record and the physical asset signals, the predictive algorithm assigning weights to the plurality of data categories in the categorized record; and a threshold determination module, configured to determine whether the qualifier score meets a one or more threshold range.

In one or more embodiments, the device may comprise a normalization module, configured to normalize, at the host processor, the plurality of data categories based on a sufficiency factor, wherein the sufficiency factor provides completeness check on the plurality of data categories by comparing the plurality of data categories to a plurality of weighted fields to determine a missing data value; and on determining the missing data value, enter a null value to the missing data value in the plurality of data categories.

In another aspect, in at least one embodiment, there is provided a computer-implemented method, performed by a host processor via a computing network. The method comprises determining, at the host processor, an input factor by analyzing a plurality of input signals, corresponding to a client identifier, received from a plurality of external systems; extracting, at the host processor, from the plurality of input signals, a corresponding record by implementing a plurality of predefined tags and generating a categorized record from the corresponding record, the categorized record including a plurality of data categories, wherein a data category corresponds to a predefined tag; selecting, at the host processor, a predictive algorithm based on the input factor; receiving, at the host processor via the computing network, physical asset signals, associated to the client identifier, from an external asset system; generating, at the host processor, a qualifier score based on a predictive algorithm applied to the categorized record and the physical asset signals, the predictive algorithm assigning weights to the plurality of data categories in the categorized record; and determining whether the qualifier score meets a one or more threshold range.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is a block diagram of an example data extraction and risk assessment system 100 in accordance with an embodiment.

FIG. 1B is a variation of the embodiment of FIG. 1A, illustrating an example block diagram of a data extraction and risk assessment system 100.

FIG. 2 is a block diagram of an example data extraction and risk assessment device 200. The device 200 includes a processor 2002 and a memory 2004.

FIG. 3A is a block diagram of an example data extraction and risk assessment device 200 of FIG. 2.

FIG. 3B is a block diagram of an example data extraction and risk assessment device 200 of FIG. 2, according to an embodiment.

FIG. 3C is a block diagram of an example data extraction and risk assessment device 200 of FIG. 2, according to an embodiment.

FIG. 4 is a flowchart 400 of an example method for processing financial data to generate a qualifier score according to an embodiment.

FIG. 5 is a flowchart 500 of an example method for processing financial data to generate a qualifier score according to an embodiment.

FIG. 6 is a screen view of an interface connected to a data extraction and risk assessment system, according to an embodiment.

FIG. 7 is a screen view 700 of an interface connected to a data extraction and risk assessment system 100, according to an embodiment

FIG. 8 is a screen view 800 of an interface connected to a data extraction and risk assessment system 100, according to an embodiment.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Existing financial risk assessment systems for tenancy and mortgage qualifications typically involve the manual filling out of forms and the use of static formulas for risk calculations. These systems rely on a single point-in-time data check, leading to potential inaccuracies as financial data can become outdated quickly. They often require considerable manual intervention and depend on physical documentation, which is prone to human-error, tampering, and fraud.

Traditional systems are also limited by their reliance on static formulas for risk assessment, which do not allow for dynamic adjustments based on real-time financial data or unique client circumstances. This results in redundant calculations that waste processor cycles and increase power consumption. The need for repeated manual data verification further adds to the computational load, slowing down overall processing speed and delaying decision-making.

Additionally, these systems are inefficient in data extraction and categorization relevant to risk assessment. They often extract a large amount of irrelevant data, which overloads the database and complicates the retrieval of relevant information. This inefficiency in data extraction and categorization not only affects the accuracy of the risk assessment but also leads to increased processing times and storage requirements.

Another notable issue with traditional systems is their inability to effectively prevent fraud. Potential tenants or property purchasers often fail to fulfill their agreements due to the submission of fraudulent or outdated physical documents or financial credentials. These documents are susceptible to tampering and forgery, complicating the verification process and leading to potential financial losses. The lack of secure, automated data verification mechanisms contributes to this problem, leaving room for fraudulent activities to go undetected. Additionally, there is a risk of error in manual entry of client information from physical documentation.

Furthermore, traditional systems often perform a single step of data receipt and verification, which may lead to inaccuracies by the time the transaction is completed. Financial data is dynamic and can change rapidly. If additional data is needed later in the process, the entire assessment must be redone, resulting in inefficiencies and increased computational burden.

These systems are also inefficient in anticipating rental and mortgage commitment defaults, which can impact operational stability for landlords and financial institutions. Static risk assessment models fail to provide ongoing monitoring and predictive insights, leading to unexpected defaults that could have been mitigated with real-time data analysis.

Furthermore, traditional systems are often restricted by slow data retrieval and storage inefficiencies. Without proper categorization and tagging of data, retrieval becomes computer resource-intensive, slowing down the entire workflow. The absence of advanced algorithms to dynamically adjust risk assessments based on new data further adds to these inefficiencies.

To address these issues, systems, devices, and methods for periodic financial data extraction and risk assessment have been developed. The system provides for accessing data directly from external systems such as banks, financial institutions, and other relevant data sources. By leveraging secure APIs (application programming interfaces), the system continuously updates in response to financial events such as transactions, asset acquisitions, and changes in liabilities. This enables the accurate assessment of financial behaviors and the prediction of transaction outcomes.

Data is extracted based on predefined tags relevant to factors necessary for risk assessment, such as income, liabilities, credit activities, and transaction histories, all associated with a client identifier. The extraction process provides that only pertinent data is collected, reducing unnecessary processing, and improving efficiency. The extracted data undergoes continuous updates until a predefined time, such as the date of a transaction, providing that the most current information is used for risk assessment. The analyzed data is then segregated and categorized into relevant categories or factors for risk calculation. The categories may include asset categories, liability categories, and income categories. Additionally, physical asset details relevant to the transaction, such as property value, location, transaction date, and rental value, etc., are received and integrated as an input factor for the predictive algorithm for risk assessment.

A predictive algorithm is applied to the categorized data. The algorithm assigns weights to the various data categories. The algorithm performs calculations to generate a qualifier score, assessing the risk and predicting financial outcomes with high accuracy. The continuous data refresh and dynamic assessment capabilities provide for the risk evaluations that are up-to-date, improving decision-making processes for financial institutions, landlords, and other stakeholders.

By automating the data extraction and analysis process through secure APIs, the system reduces manual intervention and associated processing time. The continuous updating mechanism allows real-time accuracy, minimizing the need for repeated data checks and reducing processor cycles. Advantageously, efficient data categorization and tagging streamline data storage and retrieval, improving overall system performance. Further, the predictive algorithm dynamically adjusts weights based on current data, optimizing power consumption and computational load. The secure data transmission and verification mechanisms also improve data integrity and security.

At least some of the embodiments described herein provide a predictive algorithm that is dynamically adjusted to reflect the changing importance of various factors. The relevance and selection of weights and factors are continuously updated based on real-time data and contextual changes. For instance, if a new mortgage policy sets specific limits for the Total Debt Service Ratio (TDSR) and Gross Debt Service Ratio (GDSR), the algorithm updates to incorporate these parameters, dynamically assigning different weights to determine compliance. Similarly, the algorithm adapts to legal rules or rental and mortgage policies that may affect financial risk assessments. Another example of the dynamic nature of the algorithm extends to employment types. Based on whether a client is a contractor, self-employed, full-time, or part-time employee, the algorithm filters data into appropriate decision trees and applies different weights or even distinct algorithms based on these selections. This continuous adjustment features improves the system's predictive accuracy and reliability.

At least some of the embodiments described herein include a feature for normalizing data categories based on a sufficiency factor. The sufficiency factor is designed to provide the completeness of the data categories by comparing them against a set of weighted fields to identify any missing data values. When a missing data value is detected, the system checks if the corresponding data is available in the plurality of secondary signals, as discussed in detail below. If the corresponding data value is found, the data value is automatically entered into the missing data value in the relevant data category. If the corresponding data value is not available in the secondary signals, a null value is entered to indicate the absence of data. This normalization process provides that all data categories are as complete as possible, improving the reliability and accuracy of the risk assessment. By addressing the missing data values, the system also minimizes gaps in the data set, thereby improving the quality of the predictive analysis.

At least some of the embodiments described herein include the implementation of predefined tags for data extraction. A host processor scans the input signals to extract information that matches the predefined tags. Multiple input signals are scanned to identify relevant data based on predefined tags. The predefined tags include income, liabilities, credit activities, and transaction histories. The predefined tags are configured to isolate specific pieces of information essential for the risk assessment process. Once the relevant information is identified, the categorized data is stored in a corresponding second record. The process provides that only pertinent data is collected and organized efficiently, improving both the accuracy and speed of data processing.

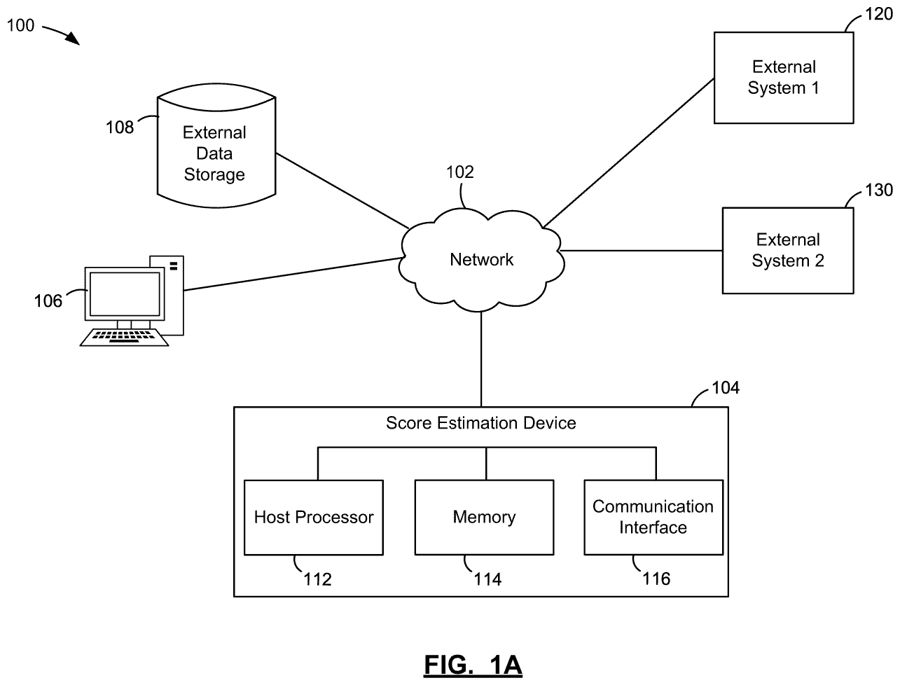

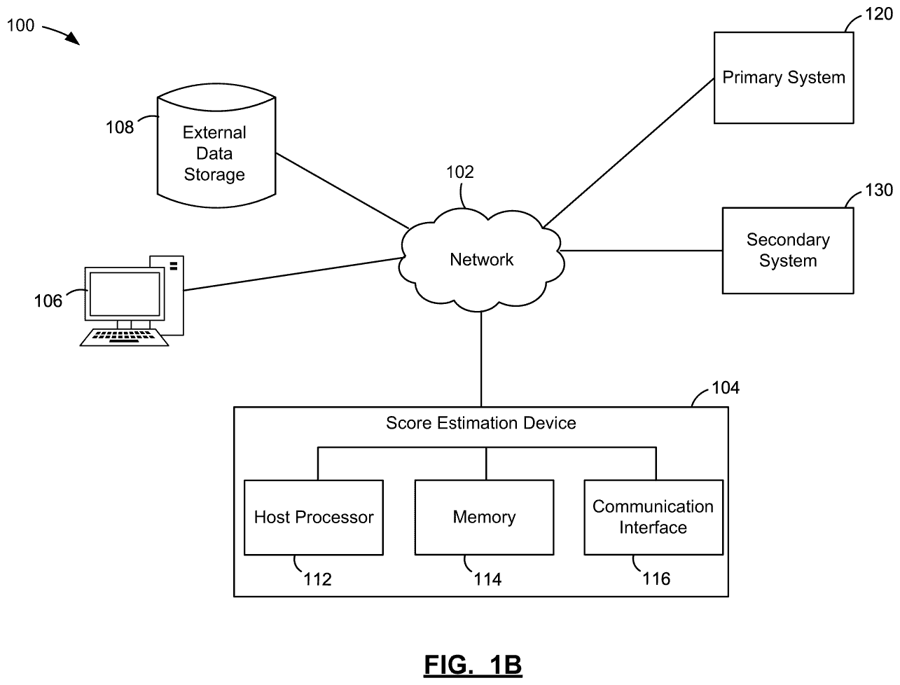

Reference is first made to FIG. 1A, which illustrates an example block diagram of a data extraction and risk assessment system 100. The system 100 includes a network 102 that connects multiple components of the system, providing for data transfer and communication. The system 100 further includes a score estimation device 104, which performs the core functions of data analysis and risk assessment. Additionally, a user terminal 106 is provided, which may be accessed by a user of the system or an administrator for monitoring and interaction purposes. External systems 120 and 130 are provided from where the data access is made, allowing the system to retrieve relevant information. The system 100 includes an external data storage 108.

The system representation shown in FIG. 1A is provided as an embodiment. There may be variations in the combination or number of such components, and in some cases, a single device may provide the functions of multiple components. For example, while FIG. 1A shows two external systems 120, 130, the system 100 may be in communication with fewer or greater number of such external systems over a wide geographic area via the network 102. Furthermore, while the external systems 120 and 130 are shown as separate components, in some cases, they can be the same devices performing both data provision and reception functions.

The score estimation device 104 includes a processor 112, a data storage 114 and a communication component 116. The score estimation device 104 can be implemented with more than one computer server distributed over a wide geographic area and connected via the network 104. The processor 112, data storage 114 and communication component 116 may be combined into a fewer number of components or may be separated into further components. The score estimation device 104 is configured to continuously retrieve data, and perform data extraction, categorization, and predictive risk assessment.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the score estimation device 104. The processor 112 can include more than one processor with each processor being configured to perform different dedicated tasks.

The processor 112 can be configured to control the operation of the score estimation device 104. For example, the processor 112 can execute instructions to manage data retrieval from external systems, providing continuous updates and accurate data acquisition. The processor 112 can also extract data by applying predefined tags to categorize relevant information. Further, the processor 112 can execute the predictive algorithms that analyze the categorized data to generate qualifier scores.

The communication component 116 can include any interface that enables the score estimation device 104 to communicate with various devices and other systems. For example, the communication component 116 can receive input signals from external systems 120, 130 such as banks, financial institutions, and other data sources via secure APIs. These input signals may include data relevant to risk assessment, such as income, liabilities, credit activities, and transaction histories. The processor 112 can then process these input signals by applying predefined tags to extract relevant information. Thereafter, the processor 112 can categorize the data into relevant categories. The processor 112 can also perform normalization to ensure data completeness. The processor 112 executes the predictive algorithms to analyze the categorized data. It generates qualifier scores and continuously updates the risk assessment based on real-time data changes.

The communication component 116 can include at least one of a serial port, a parallel port or a USB port, in some embodiments. The communication component 116 may also include an interface to component via one or more of an Internet, Local Area Network (LAN), Ethernet, Firewire, modem, fiber, or digital subscriber line connection. Various combinations of these elements may be incorporated within the communication component 116.

The data storage 114 can include RAM, ROM, one or more hard drives, one or more flash drives, or some other suitable data storage elements such as disk drives. The data storage 114 can store the extracted and processed data. The data storage 114 can also store the instructions executed by the processor 112. Additionally, the data storage 114 can maintain logs of all transactions and updates.

The external data storage 108 can store data similar to that of the data storage 114. In some embodiments, the external data storage 108 can be a third-party data storage system, such as Plaid™, which stores input data for analysis by the score estimation device 104. The data stored in the external data storage 108 can be retrieved by the score estimation device 104 via the network 102.

The external systems 120, 130 can include a processor and memory, and may be an electronic tablet device, a personal computer, workstation, server, portable computer, mobile device, personal digital assistant, laptop, smartphone, WAP phone, an interactive television, video display terminals, gaming consoles, portable electronic devices, or any combination of these. These external systems 120, 130 are designed to interact with the score estimation device 104 to provide and receive data necessary for financial risk assessments. For instance, the external system 120 can be associated with a bank, providing access to detailed financial records, including transaction histories, account balances, and income details.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the score estimation device 104, the external systems 120 and 130, and the external data storage 108 and the user terminal 106.

The user terminal 106 can include a processor and memory, and may be a computer, tablet, workstation, portable computer, mobile device, personal digital assistant, laptop, or any combination of these devices. Separate user terminals 106 may exist for multiple users, including end-users, assessors, and administrators.

For end-users, the user terminal 106 may provide an interface to input data such as a transaction application, view their financial status, and receive updates on their risk assessments. Assessors can use the terminal 106 to review detailed financial reports, analyze risk scores, and make informed decisions based on the data provided by the score estimation device 104. Administrators can utilize the terminal 106 to monitor system performance, manage user access, and oversee the overall operation of the data extraction and risk assessment processes.

The system 100 interfaces with external systems 120 and 130 to extract necessary data for risk assessment. The external systems 120 and 130 can be associated with banks, financial institutions, or other relevant data sources. The data extraction can be performed using secure APIs, providing real-time access to accurate and up-to-date financial information.

The external systems 120 and 130 can provide input signals in formats such as JSON. The input signals include detailed transaction histories, balance details, and credit activities. The score estimation device 104, through its communication component 116, receives these input signals from the external systems 120 and 130. The processor 112 then processes these input signals by applying predefined tags to extract a data record. The data record may include information on income, liabilities, and credit activities.

In an embodiment, the system 100 leverages real-time financial data directly from banking APIs. The data is continuously updated in response to financial events such as transactions, asset acquisitions, and changes in liabilities. The processor 112 categorizes the extracted data into relevant categories and performs normalization to ensure data completeness.

The score estimation device 104 is configured to receive, at the host processor 112 via the network 102, a plurality of input signals from a plurality of external systems 120 and 130. These input signals correspond to a client identifier. The plurality of input signals generates a corresponding first record.

Direct data access is provided between the communication component 116 and the external systems 120 and 130. The connection is established through secure APIs (Application Programming Interfaces). Secure APIs provide interfaces that allow applications to communicate with each other using predefined protocols and security measures. These measures include encryption and authentication protocols to ensure that the data transferred between systems is protected from unauthorized access and tampering. Input signals such as transaction histories, account balances, and personal identification details are encrypted by protocols including TLS (Transport Layer Security) or SSL (Secure Sockets Layer). The encryption protocols encrypt the input signals at both ends of the transmission, ensuring that any intercepted data remains unreadable to unauthorized parties. Encryption algorithms involved in the protocols may include AES (Advanced Encryption Standard) and RSA (Rivest-Shamir-Adleman).

The communication interface 116 is configured to send a request to the external systems 120 and 130. The external systems 120 and 130 includes one or more of employment data server, financial institution server, credit reporting server, estate servers, criminal records server, and client data servers.

The system 100 receives input signals corresponding to a client identifier to generate a corresponding first record. The input signals are received at the host processor 112 via the network 102 from a plurality of external systems 120 and 130. Input signals may be received as raw data. Examples of input signals include transaction logs, account statements, income records, credit activities, and previous tenancy records. The input signals may be received in various formats such as JSON, XML, or CSV.

In an embodiment, the input signals may include the relevant details, such as the categorized data which may not be require further categorization. The input signals may already include information categorized based on the various factors of the predictive algorithm. In such cases, the input signals can be directly introduced into the predictive algorithm for further processing.

The input signals correspond to a client identifier. The client identifier includes a unique identifier assigned to each applicant. Examples of client identifiers include Social Security Numbers (SSNs), Tax Identification Numbers (TINs), or unique customer IDs assigned by the financial institution, etc. This client identifier provides for linking the input signals to the correct individual. The system 100 also provides a Know Your Customer (KYC) feature, which works in conjunction with the client identifier. When input signals are received, the system cross-references the client identifier with KYC data to verify the identity of the applicant.

Once the input signals associated with the client identifier are received, the host processor 112 generates a corresponding first record. This first record includes the input signals received from multiple external systems 120 and 130. The collective retrieval of input signals into a first record provides that all information is accessible for subsequent processing steps.

The host processor 112 is configured to analyze the corresponding first record to extract a corresponding second record. The analysis includes implementing a plurality of predefined tags. Predefined tags are configured to identify and isolate relevant pieces of information within the first record.

The host processor 112 scans the input signals in the first record for data that matches the predefined tags. The predefined tags are configured to capture specific types of information, such as income, liabilities, credit activities, and transaction histories. By using these tags, the system can extract the relevant data points required for further processing.

Once the relevant data is extracted, the host processor 112 generates a corresponding second record. The second record includes data that has been filtered based on the predefined tags.

Simultaneously, the host processor 112 generates a categorized record from the corresponding second record. The categorized record includes a plurality of data categories, each corresponding to a predefined tag. Data categories may include asset categories, liability categories, income categories, and credit activity categories. Each category includes the relevant data points extracted from the first record. The asset category covers asset data associated with a client identifier, such as real estate properties, vehicles, savings accounts, investment portfolios, and valuable personal property. The host processor 112 applies the asset tag to isolate the asset data points from the input signals. The liability category includes data associated to financial obligations of the client, such as outstanding loans, credit card debts, mortgages, and any other forms of debt. The host processor 112 uses the liability tag to extract these data points from the input signals. The income category includes data associated to income for the client, including salary, bonuses, rental income, investment returns, and other earnings. The host processor 112 applies the income tag to isolate income-related data from the input signals. The host processor 112 may categorize the income data into regular (e.g., salary, fixed rental income) and irregular (e.g., bonuses, investment returns) subcategories.

According to an embodiment, the host processor 112 is configured to normalize the plurality of data categories based on a sufficiency factor. The sufficiency factor is a relational metric configured to verify the completeness and accuracy of the data categories. The host processor 112 can compare the data categories in the categorized record to a plurality of weighted fields in the sufficiency factor. Each weighted field represents a data point that is intended to be input into the predictive algorithm. By comparing the data categories to these weighted fields, the host processor 112 can identify any missing data values that need to be addressed.

Upon determining that a data value is missing, the host processor 112 takes appropriate action to handle the incomplete data. If the corresponding data value is unavailable, the host processor 112 enters a null value into the missing data field within the relevant data category. This feature provides that the data categories are standardized and complete, avoiding any gaps that could impact the accuracy of the risk assessment. The normalization process improves data integrity and consistency, providing a foundation for subsequent predictive analysis.

The host processor 112 is configured to receive, via the network 102, physical asset signals associated with the client identifier from an external asset system.

The physical asset signals may relate to the property that is intended to be purchased or rented. The physical asset signals include the property value, location data, transaction date, rental value, down payment, and rental deposit.

The system 100 is configured to perform continuous monitoring of data for a preset period, executed by the host processor 112. The continuous monitoring is provided for the data values included in the categorized data. The host processor 112 continuously retrieves new data from external systems 120 and 130 through the communication component 116. The communication component 116 establishes and maintains secure connections via APIs to these external systems, providing for real-time data transmission to the host processor 112.

The received data includes updates to previously categorized record such as transaction histories, account balances, and asset valuations. For example, if there are changes in an applicant's financial activities, such as new transactions or changes in account balances or salary, this information is sent as updated input signals. The host processor 112 processes these updates by comparing them to the existing categorized data. The host processor 112 checks for new data points or changes in existing data points and updating the records accordingly.

The host processor 112 continuously updates the categorized record by integrating the new data. The continuous update process ensures that the categorized data remains current. Each time new data is received, the host processor 112 re-evaluates the completeness of the data categories and updates any relevant fields.

The host processor 112 may also maintain a schedule for periodic data refreshes, providing that all data is reprocessed at regular intervals, such as each day, weekly or monthly. In various embodiments, the data is continuously refreshed until a predefined end date, such as, for example, closing of a new condominium, closing of a purchase of a property, rental commencement date, rental termination date, etc. This scheduled refresh includes retrieval of the latest data from external systems 120 and 130, processing any new or changed data, and updating the categorized record. By continually integrating new data and refreshing the existing data, the system 100 provides that the predictive analysis is based on the most current and accurate information available.

For example, if a buyer purchases a high-value item like a boat or experiences a job loss, the system 100 detects these changes through the continuous data feed. Specifically, the host processor 112 identifies such changes by analyzing transaction records received from updated input signals. The host processor 112 then adjusts the data value in the categorized record to reflect these changes. This continuous data updating provides that the data remains current and accurately represents the latest information throughout the monitoring period.

In the context of renting, the system 100 continuously monitors tenants' financial activities by providing live updates on their ability to meet rental obligations. The host processor 112 is configured to refresh and reprocess financial data on a periodic basis, such as weekly or monthly. This periodic data refresh involves retrieving the latest financial information from external systems 120 and 130, processing any new or changed data, and updating the categorized record. By regularly updating the financial data, the system 100 ensures that the categorized data is always up-to-date, providing the most accurate and current information available.

The host processor 112 continuously tracks changes in financial behaviors and significant events by analyzing the updated input signals received from external systems 120 and 130. The system 100 provides real-time monitoring and alerts for significant data changes. For instance, in renting implementations, the host processor 112 generates alerts when updated input signals, such as missed payments or significant drops in account balances, indicate a potential for tenant default. The processor analyzes these signals to detect patterns or anomalies that suggest financial instability. The anomaly detection allows stakeholders to take proactive measures based on the latest data, mitigating risks associated with rental income disruptions.

The continuous monitoring and real-time updates are also supported by the communication component 116, which conducts secure and timely data transmission between the external systems 120 and 130 and the host processor 112. By maintaining a continuous flow of updated information, the system 100 improves the accuracy and reliability of data assessments.

The host processor 112 is configured to generate a qualifier score by applying a predictive algorithm to the categorized record and the physical asset signals. The predictive algorithm operates by assigning a plurality of weights to various data values within each data category. For example, the predictive algorithm evaluates the categorized data, which includes multiple categories such as transaction histories, account balances, and asset valuations. Each category includes data values that are weighted according to their significance in the overall assessment.

According to an embodiment, the predictive algorithm calculates a qualifier score by assigning weights to data values in the plurality of data categories within the categorized record. Data values within the data categories may be either positive factors or negative factors. Positive factors include data values associated with factors such as down payment data, monthly income data, credit score data, prior asset ownership data, and consistent employment history. The credit score data may include one or more of credit score, gross debt service ratio, and total debt service ratio. Correspondingly, negative factors include data values associated with liability data, previous default data, high debt-to-income ratios, and irregular payment histories, etc. Each data value has an associated weight, and a product is computed for the data value and its respective weight.

The system 100 assigns different points to each factor based on its importance or the value specified by the administrator. For instance, a high credit score might receive more points compared to a lower score, while significant outstanding liabilities might result in a point deduction. The system evaluates each data value or range of values, assigning a corresponding number of points based on its impact on the overall financial assessment.

Additionally, the weights associated with the nature of the applicant's employment are considered by the predictive algorithm. For example, a plurality of weights may be assigned based on the type of employment: a weight of 10 may be assigned to full-time employment, 9 to a contractor with guaranteed hours, 8 to part-time employment, 7 to self-employment, and 5 to part-time employment. Furthermore, data weights may be assigned to the applicant's employment history. For instance, a length of employment over 5 years might be weighted at 10, 3-5 years at 8, and less than 3 years at 6. The weights are aggregated to form an employment data value, which is then processed by the predictive algorithm. Note that these examples are illustrative, and different sequences of weights may be assigned by an administrator based on specific preferences or criteria.

Additionally, the predictive algorithm assigns weights to the target physical asset values. The target physical asset values include data points such as the occupancy status of the property. The occupancy status is represented by a binary value, such as 1 or 0, indicating whether the property will be occupied by the applicant or rented out. The target physical asset values also include the purchase price data of the property to be acquired. For tenancy assessments, the target physical asset values include the monthly rental price data associated with the property. Each of these target physical asset values has an associated weight, assigned based on its predetermined relevance to the overall evaluation. The host processor 112 calculates a product for each data value and its respective weight. The algorithm then integrates the weighted target physical asset values into the overall calculation.

The calculation of the qualifier score is based on the aggregation of weighted data values. The system aggregates the weighted data values of positive factors and subtracts the cumulative weighted data values of negative factors. The predictive algorithm provides that the final qualifier score reflects the balance of positive and negative financial behaviors, providing a comprehensive assessment of the client's financial reliability.

The system 100 integrates continuous monitoring with predictive analysis to provide real-time updates to the qualifier score. The host processor 112, through the communication component 116, continuously retrieves new input signals from external systems 120 and 130. As new input signals are received, the host processor 112 processes the updated data values by comparing them to the existing categorized data.

The predictive algorithm is configured to dynamically adjust the qualifier score based on the updated data. Each data value within the categorized record has an associated weight, and the algorithm recalculates the product of these data values and their respective weights. For instance, if a new transaction indicates a significant expenditure or an increase in account balances, the host processor 112 updates the corresponding data values and recalculates the score.

The score recalibration process provides that the qualifier score is always current. The host processor 112 integrates the new weighted data values into the existing score, maintaining a real-time assessment of the applicant's financial credentials. The continuous data updates are reflected in the recalculated score, providing stakeholders with the most accurate and timely information.

The system 100 is configured to display the updated qualifier score on a platform interface accessible to users, such as applicants, lenders, or landlords. Each time new data is received and processed, the host processor 112 updates the displayed score dynamically.

For example, in mortgage applications, if a buyer makes a large purchase or experiences a job loss, the host processor 112 identifies these changes through the updated transaction records. The predictive algorithm then adjusts the weights and recalculates the qualifier score to reflect these changes. Similarly, for rental applications, if a tenant misses a payment or shows significant drops in account balances, the host processor 112 updates the score based on these new inputs.

The predictive algorithm within the system 100 dynamically determines the factors it processes and the weights assigned to each factor based on real-time data and administrative policies. The host processor 112 manages a database of factors identified as positive or negative and assigns weights to each factor according to predefined rules and real-time data inputs.

The host processor 112 continuously monitors data values from the categorized record, analyzing their impact on the overall risk assessment. Positive factors, such as steady income, low debt-to-income ratios, and high credit scores, are identified and assigned positive weights. Negative factors, such as high outstanding liabilities, unemployment, and previous defaults, are identified and assigned negative weights. The host processor 112 dynamically adjusts these weights based on the current data values and their interactions with other factors.

For instance, the system 100 tracks employment data through input signals received from external systems 120 and 130. If an applicant's employment status changes to unemployed, the host processor 112 identifies this change and updates the corresponding data value in the categorized record. The predictive algorithm then recalculates the weight for the unemployment factor, assigning a higher negative weight due to its significant impact on financial stability. The employment status data value is then multiplied by its assigned weight and integrated into the overall qualifier score.

Conversely, if the applicant is employed, the host processor 112 further evaluates related data values such as the number of years at the current position and whether the applicant has guaranteed hours. The system retrieves these data values and assigns weights accordingly. For example, a long-term employment history with guaranteed hours is assigned a higher positive weight. These weighted data values are then processed by the predictive algorithm to update the overall qualifier score.

In another instance, if the employment status of an applicant is part-time, which typically carries a lesser weight due to its perceived instability, the host processor 112 can moderate the lesser weight by considering other positive factors. The host processor 112 retrieves data values related to the applicant's liquid assets and down payment amount from the categorized record. If the applicant has considerable liquid assets or a large down payment, the host processor 112 assigns higher positive weights to these factors. The predictive algorithm then integrates these positively weighted data values, effectively moderating the impact of the lesser weight associated with part-time employment. This balanced approach ensures that the qualifier score accurately reflects the applicant's overall financial stability, even when individual factors might initially appear less favorable.

The dynamic adjustment of weights is achieved through predefined rules set by the administrator. The host processor 112 applies these rules to real-time data inputs. For example, if a new administrative policy emphasizes the importance of credit scores, the system retrieves credit score data values from the categorized record and increases their weights. The algorithm processes these weighted data values, recalculating the qualifier score to reflect the updated policy.

According to another embodiment, the dynamic adjustment of weights in the predictive algorithm is updated through predefined Total Debt Service Ratio (TDSR) and Gross Debt Service Ratio (GDSR) limits. The host processor 112 monitors the data values associated with TDSR and GDSR within the categorized record. The TDSR and GDSR ratios provide for assessing the applicant's ability to manage debt relative to their income, and influence the overall risk assessment.

The host processor 112 retrieves the TDSR and GDSR values from the categorized data. If a new mortgage policy is introduced that sets specific limits for these ratios, the system 100 dynamically adjusts the weights assigned to these factors. For instance, if the policy stipulates a maximum TDSR of 40% and a maximum GDSR of 32%, the predictive algorithm recalibrates the weights based on whether the applicant's ratios meet these thresholds.

If the applicant's TDSR and GDSR are within the acceptable limits, the host processor 112 assigns higher positive weights to these data values. Conversely, if the ratios exceed the predefined limits, the algorithm assigns higher negative weights. This dynamic adjustment ensures that the weight associated with debt service ratios accurately reflects their importance in the risk assessment.

The algorithm processes these adjusted weights in conjunction with other relevant data values. By integrating the recalibrated TDSR and GDSR weights, the host processor 112 provides a comprehensive evaluation that aligns with the latest mortgage policy requirements. Additionally, the host processor 112 can dynamically update other factors' weights based on their interaction with TDSR and GDSR. For example, if the applicant has a high income but also high debt levels, the system may assign varying weights to balance these factors.

In an embodiment, the host processor 112 evaluates combinations of factors and their associated weights to assign points that reflect the interaction between multiple data points. For example, the Gross Debt Service (GDS) ratio, which represents the percentage of monthly household income that covers housing costs, is analyzed in conjunction with the down payment amount. If the GDS ratio and the down payment amount both fall within a preferable range, the system assigns higher points to this combination. In another example, a low GDS combined with a high down payment results in a higher overall score compared to a high GDS with the same down payment. The host processor 112 calculates the product of the GDS and down payment values with their respective weights, dynamically adjusting these weights based on predefined rules.

The host processor 112 is also configured to analyze patterns and combinations of data values to assign points accurately. For example, the host processor 112 can scan transaction reports, to identify for consistent patterns such as regular deposits and fixed withdrawals. The analysis provides for determining the applicant's actual disposable income. For example, if the assessment shows a pattern of fixed withdrawals, the system dynamically calculates the actual disposable income, which is then used by the predictive algorithm for further calculations. The host processor 112 also uses the transaction report to detect any irregularities, such as substantial temporary deposits made just before the rent or mortgage application, indicating potential financial instability. Similarly, the asset holdings of a client are assessed by evaluating the equity and liabilities associated with each asset. The host processor 112 retrieves data from multiple sources such as credit bureaus, mortgage institutions, and credit organizations to comprehensively evaluate all liabilities.

Additionally, the predictive algorithm dynamically adjusts based on applicable legal rules and rental or mortgage policies. The host processor 112 continuously updates the model to reflect these regulations, providing compliance and relevance. For instance, changes in legal requirements for down payment minimums or maximum allowable debt ratios can prompt the host processor 112 to recalibrate the weights assigned to related factors. Established mortgage rules further influence the weight assignment process. For example, if a mortgage policy stipulates that approval is not granted when the purchase price exceeds $999,999 with a down payment of less than 20%, the system applies a significant point deduction for such combinations. The host processor 112 identifies these specific combinations and adjusts the weights and points accordingly, providing that the final qualifier score accurately reflects these critical policy considerations.

The host processor 112 continuously recalibrates the weights of various factors based on real-time data changes and administrative policies. This involves analyzing the impact of each data value on the overall risk assessment, adjusting the weights, and integrating the weighted data values into the final qualifier score. By maintaining an up-to-date qualifier score, the system 100 provides that the predictive analysis remains accurate and relevant.

The output of the predictive algorithm is a qualifier score. By calculating the overall points from these individual evaluations, the system 100 generates a comprehensive and accurate qualifier score. This score provides stakeholders with a reliable measure of the applicant's financial health. A higher score suggests a greater likelihood of mortgage approval or successful rental application, while a lower score indicates a lower likelihood. The score provides a clear and understandable metric that stakeholders, such as builders, sellers, landlords, and financial institutions, can use to make informed decisions. The system 100 also uses this score to match applicants with appropriate loan products and provide tailored recommendations.

For mortgage assessments, the score reflects the applicant's ability to close the mortgage based on various factors including credit score, income, down payment, and debt service ratios. For rental assessments, the score evaluates the applicant's ability to pay rent on time, considering factors like employment status, income consistency, and past rental history.

Upon receiving the qualifier score, the host processor 112 determines whether the score falls within one or more of the predefined ranges. These ranges are set to categorize the scores into different levels of financial reliability. For example, scores between 1 to 100 can be segmented into ranges such as over 80 for a qualifier range, 60-80 for a borderline range, and less than 60 for a disqualified range.

The host processor 112 evaluates the score by comparing the score against the predefined ranges. The comparison classifies the applicant's financial reliability and provides an immediate assessment of their likelihood to meet mortgage or rental obligations. The system 100 continuously updates the score based on real-time transactions, deposits, withdrawals, and other liabilities, ensuring that the most current data is reflected in the score. Consequently, the range determination may also be dynamically updated.

The user of the platform has real-time access to the scores through a user interface. The host processor 112 updates the displayed score dynamically as new data is received and processed. To enhance user experience and clarity, the host processor 112 may provide different color coding to indicate the range to which the score belongs. For instance, scores in the qualifier range may be displayed in green, borderline scores in yellow, and disqualified scores in red.

Reference is now made to FIG. 1B, which is a variation of the embodiment of FIG. 1A. FIG. 1B illustrates an example block diagram of a data extraction and risk assessment system 100. The system 100 includes a network 102 that connects multiple components, enabling data transfer and communication. The system 100 includes a score estimation device 104 for data analysis and risk assessment. Additionally, a user terminal 106 allows users or administrators to monitor and interact with the system. The system 100 includes primary systems 120 and secondary systems 130.

Primary systems 120 refer to external sources with high data credibility and are generally assigned by the system administrator. The primary sources include credit bureaus, tax authorities, and banking systems, which provide reliable and authoritative data. Secondary systems 130 refer to other sources of information, which may include materials provided by the applicant, personal references, employment verification from employers, and rental history from landlords.

The other components, such as the score estimation device 104, user terminal 106, and external data storage 108, may be similar to the components in FIG. 1A.

However, modifications necessary to work with the present embodiment may be made to these components.

The system 100 receives input signals corresponding to a client identifier to generate a corresponding first record. The input signals are received at the host processor 112 via the network 102 from a plurality of external systems, including primary systems 120 and secondary systems 130.

Once the input signals associated with the client identifier are received, the host processor 112 generates a corresponding first record. The first record consolidates the input signals received from both the primary systems 120 and secondary systems 130.

The host processor 112 scans the input signals in the first record for data that matches the predefined tags. The predefined tags include an asset tag, a liability tag, and a transactions tag. An asset tag extracts all relevant assets associated with a client identifier. The asset tag captures data such as property values, vehicle ownership, investment portfolios, and other significant assets. The asset tag provides a comprehensive understanding of the client's asset base, as an indicator for financial stability and collateral. The liability tag identifies and extracts all liabilities linked to the client. The liability tag extracts data associated to outstanding loans, credit card debts, mortgages, and other financial obligations. By isolating the liability data, the host processor 112 assesses the client's debt levels and repayment capacities. The transactions tag extracts the data associated to client's transaction histories, covering income deposits, expenditures, and recurring financial activities. The transactions tag provides for monitoring cash flow patterns and financial behaviors. The predefined tags are configured to identify and isolate specific pieces of information relevant to the risk assessment process, such as income, liabilities, credit activities, and transaction histories.

Once the relevant data is extracted, the host processor 112 generates a corresponding second record. The second record includes data that has been filtered and categorized based on the predefined tags. This second record consists of a plurality of primary signals received from the primary systems 120 and a plurality of secondary signals received from the secondary systems 130. This categorization distinguishes the data from high-credibility sources from other sources.

The host processor 112 is configured to verify the corresponding second record by comparing a primary signal subset from the plurality of primary signals to a secondary signal subset from the plurality of secondary signals.

The host processor 112 identifies and isolates the primary signal subset and the secondary signal subset based on the predefined tags. The primary signal subset may include high-credibility data such as income reports from banking systems 120 or tax authorities. The secondary signal subset may include corresponding data such as income details provided by the applicant or personal references 130. The feature of selecting and comparing data subsets is more efficient than comparing the entire dataset, as it reduces computational load and accelerates the verification process. The subset is selected to represent the most relevant data points, ensuring that key information is cross-verified without the need for exhaustive comparison. For example, the host processor 112 may dynamically select subsets based on metadata tags, such as transaction amounts, ensuring that only the most pertinent entries are compared. Additionally, subsets can be chosen based on predefined criteria, such as high-value transactions or data entries with higher potential for discrepancies.

The host processor 112 is configured to perform a data matching process to compare the primary and secondary signal subsets. This comparison can be implemented using various techniques, by a checksum comparison wherein the host processor 112 generates checksums for each data entry in the primary and secondary signal subsets. By comparing the checksums, the system can quickly identify matching and non-matching entries. Alternatively, the host processor may implement pattern matching algorithms used to detect similarities between the primary and secondary signal subsets. The algorithms are configured to handle minor discrepancies in data formatting or entry errors. Additionally, the host processor 112 can apply statistical methods to compare the primary and secondary signals. For example, it can use correlation coefficients to measure the degree of similarity between the two data sets.

If the primary signal subset matches the secondary signal subset, the host processor 112 generates a verified signal. This verified signal indicates that the data from the primary and secondary sources are consistent, enhancing the credibility of the information.

If discrepancies are found between the primary and secondary signal subsets, the host processor 112 may flag these entries for further review, generate an error signal, or request additional verification.

Upon receiving a verified signal, the host processor 112 segregates the plurality of primary signals to generate a categorized record. The categorized record includes a plurality of data categories, each corresponding to a predefined tag. Data categories may include asset categories, liability categories, income categories, and credit activity categories. Each category is populated with relevant data points extracted from the primary signals. For example, asset categories might include property values and asset ownership details, while liability categories encompass outstanding debts and payment obligations. By categorizing the primary signals in this manner, the host processor 112 provides that the data is systematically organized and readily accessible for further predictive analysis and risk assessment.

According to an embodiment, the host processor 112 is configured to normalize the plurality of data categories based on a sufficiency factor. The sufficiency factor is a metric configured to verify the completeness and accuracy of the data categories. The host processor 112 compares the data categories in the categorized record to a plurality of weighted fields in the sufficiency factor. Each weighted field represents a data point required for the predictive algorithm. By comparing the data categories to these weighted fields, the host processor 112 can identify any missing data values that need to be addressed.

Upon determining that a data value is missing, the host processor 112 is configured to take appropriate action to complete the data categories. If a corresponding data value is available in the plurality of secondary signals, the host processor 112 retrieves and enters the corresponding data value into the missing data field within the relevant data category. This retrieval process provides that the data categories are as complete as possible by utilizing secondary sources to fill any gaps.

However, if the corresponding data value is unavailable in the plurality of secondary signals, the host processor 112 enters a null value into the missing data field within the relevant data category. This feature provides that all data categories are standardized and that any missing data is explicitly marked, avoiding potential inaccuracies in the risk assessment.

The subsequent operations performed by the components within the system 100 of this embodiment may be similar to the operations performed by the components described in FIG. 1A. The following are a concise account, and there may be additional processes involved as described in FIG. 1A.

The host processor 112 is configured to receive, via the network 102, physical asset signals associated with the client identifier from an external asset system. The system 100 performs continuous monitoring of data for a preset period, executed by the host processor 112. Continuous monitoring is provided for the data values included in the categorized data. The host processor 112 continuously retrieves new data from external systems 120 and 130 through the communication component 116, which establishes and maintains secure connections via APIs, ensuring real-time data transmission to the host processor 112.

The host processor 112 is configured to generate a qualifier score by applying a predictive algorithm to the categorized record and the physical asset signals. The predictive algorithm operates by assigning a plurality of weights to various data values within each data category. For example, the predictive algorithm evaluates the categorized data, which includes multiple categories such as transaction histories, account balances, and asset valuations. Each category includes data values that are weighted according to their significance in the overall assessment.

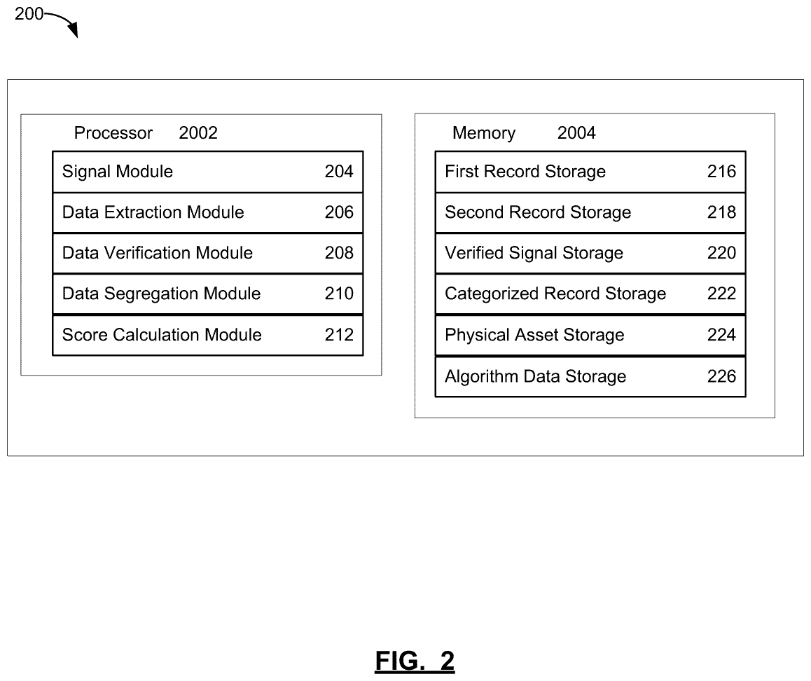

Reference is now made to FIG. 2, which illustrates an example block diagram of a data extraction and risk assessment device 200. The device 200 includes a processor 2002 and a memory 2004.

The device 200 includes a signal module 204. The signal module 204 is configured to receive a plurality of input signals from a plurality of external systems. The input signals correspond to a client identifier and generate a corresponding first record.

Direct data access is facilitated between the signal module 204 and the external systems through secure APIs (Application Programming Interfaces). The secure APIs provide interfaces that allow applications to communicate using predefined protocols and security measures.

Upon receiving input signals corresponding to a client identifier, the signal module 204 processes the input signals and generates a corresponding first record and stores it in the first record storage 216 within the memory 2004. The input signals are received in various formats, such as JSON, XML, or CSV, and include data like transaction logs, account statements, income records, credit activities, and previous tenancy records.

In an embodiment, the input signals are received from one or more types of external systems, such as primary systems and secondary systems. Primary systems 120 refer to external sources with high data credibility, such as credit bureaus, tax authorities, and banking systems. These systems provide reliable and accurate financial data, ensuring the authenticity of the information received. Conversely, secondary systems refer to other external sources, including data provided by the applicant, personal references, and less formal sources. Examples of secondary systems include employment verification services, previous landlords, and personal references.

The device 2002 includes a Data Extraction Module 206. The Data Extraction Module 206 is configured to analyze the corresponding first record stored in the First Record Storage 216. The analysis include implementing a plurality of predefined tags to identify and isolate relevant pieces of information within the first record.

The Data Extraction Module 206 scans the input signals in the first record for data that matches the predefined tags. The predefined tags are configured to capture specific types of information, such as income, liabilities, credit activities, and transaction histories. By using these tags, the Data Extraction Module 206 can extract the relevant data points required for further processing.

Once the relevant data is extracted, the Data Extraction Module 206 generates a corresponding second record. This second record, which is stored in the Second Record Storage 218, includes data filtered based on the predefined tags. Simultaneously, the Data Extraction Module 206 generates a categorized record from the corresponding second record. The categorized record includes a plurality of data categories, each corresponding to a predefined tag. This categorized record is then stored in the Categorized Record Storage 222.

The Data Extraction Module 206 is also configured to normalize the plurality of data categories based on a sufficiency factor. The sufficiency factor is a metric configured to verify the completeness and accuracy of the data categories. The Data Extraction Module 206 can compare the data categories in the categorized record stored in the Categorized Record Storage 222 to a plurality of weighted fields in the sufficiency factor. Each weighted field represents a data point intended to be input into the predictive algorithm. By comparing the data categories to these weighted fields, Data Extraction Module 206 can identify any missing data values that need to be addressed. Upon determining that a data value is missing, the Data Extraction Module 206 takes appropriate action to handle the incomplete data. If the corresponding data value is unavailable, the Data Extraction Module 206 enters a null value into the missing data field within the relevant data category.

In a second embodiment, the Data Extraction Module 206 is configured to analyze the corresponding first record to extract a corresponding second record by implementing a plurality of predefined tags. The second record includes a plurality of primary signals received from the primary systems and a plurality of secondary signals received from the secondary systems. The Second Record Storage 218 in the present embodiment distinguishes high-credibility data from primary sources, such as credit bureaus and tax authorities, from other data sources provided by the applicant or personal references.

In the second embodiment, the Data Verification Module 208 is then configured to verify the corresponding second record by comparing a primary signal subset from the plurality of primary signals to a secondary signal subset from the plurality of secondary signals. The comparison generates a verified signal when the primary and secondary signals match. The verified signal is stored in the Verified Signal Storage 220. The Data Verification Module 208 is configured to dynamically selecting subsets based on metadata tags, such as transaction amounts, ensuring that only the most pertinent entries are compared. Techniques like checksum comparison, pattern matching algorithms, and statistical methods may be used to perform this data matching process efficiently.

In the second embodiment, upon receiving a verified signal, the Data Segregation Module 210 is configured to segregate the plurality of primary signals to generate a categorized record. The categorized record includes a plurality of data categories, each corresponding to a predefined tag, and is stored in the Categorized Record Storage 222. Data categories may include asset categories, liability categories, income categories, and credit activity categories.

In the second embodiment, the Data Extraction Module 206 is configured to normalize the plurality of data categories based on a sufficiency factor. The Data Extraction Module 206 compares the data categories in the categorized record stored in the Categorized Record Storage 222 to a plurality of weighted fields in the sufficiency factor. Upon determining that a data value is missing, the Data Extraction Module 206 takes appropriate action to complete the data categories. If a corresponding data value is available in the plurality of secondary signals stored in the Verified Signal Storage 220, the Data Extraction Module 206 retrieves and enters the corresponding data value into the missing data field within the relevant data category. However, if the corresponding data value is unavailable in the plurality of secondary signals, the Data Extraction Module 206 enters a null value into the missing data field within the relevant data category.

The Signal Module 204 is configured to receive physical asset signals associated with the client identifier from an external asset system. The physical asset signals may relate to the property that is intended to be purchased or rented. The physical asset signals are stored in the Physical Asset Storage 224.

The device 202 is configured to perform continuous monitoring of data for a preset period. The Signal Module 204 continuously receives updated data from external systems. The updated data may include transaction histories, account balances, and asset valuations. The Data Extraction Module 206 integrates the new data into the categorized record stored in the Categorized Record Storage 222, ensuring that the categorized data remains current. The Signal Module 204 also maintains a schedule for periodic data refreshes, providing that all data is reprocessed at regular intervals, such as daily, weekly, or monthly. This scheduled refresh involves retrieving the latest data from external systems, processing any new or changed data, and updating the categorized record. The continuous monitoring capability allows the device 202 to track changes in financial behaviors and significant events by analyzing the updated input signals received from the external systems.

The Score Calculation Module 212 is configured to generate a qualifier score by applying a predictive algorithm to the categorized record and the physical asset signals. The predictive algorithm operates by assigning a plurality of weights to various data values within each data category stored in the Categorized Record Storage 222 and the Physical Asset Storage 224. The algorithm calculates a qualifier score by evaluating both positive and negative factors within the data categories. Positive factors may include data values such as high monthly income, strong credit scores, and significant down payments. Negative factors may include high liabilities, previous default history, and irregular payment patterns.

The predictive algorithm dynamically assigns different points to each factor based on its importance or the value specified by the administrator. For example, the algorithm considers the nature of the applicant's employment, assigning higher weights to stable, full-time employment and lower weights to part-time or contract work. Additionally, the algorithm evaluates target physical asset values, such as the occupancy status of the property and the monthly rental price data for tenancy assessments, assigning appropriate weights based on these factors' relevance to the overall financial risk assessment.

The dynamic adjustment of weights may also be achieved through predefined rules set by the administrator. The Score Calculation Module 212 applies the rules to real-time data inputs. For example, if a new administrative policy emphasizes the importance of credit scores, the system retrieves credit score data values from the categorized record and increases their weights. The algorithm processes these weighted data values, recalculating the qualifier score to reflect the updated policy.

According to another embodiment, the dynamic adjustment of weights in the predictive algorithm is updated through predefined Total Debt Service Ratio (TDSR) and Gross Debt Service Ratio (GDSR) limits. The Score Calculation Module 212 monitors the data values associated with TDSR and GDSR within the categorized record. The TDSR and GDSR ratios provide for assessing the applicant's ability to manage debt relative to their income, and influence the overall risk assessment.

The calculation of the qualifier score is based on the aggregation of weighted data values. The system aggregates the weighted data values of positive factors and subtracts the cumulative weighted data values of negative factors. The process results in a comprehensive score that reflects the balance of positive and negative financial behaviors.

The Algorithm Data Storage 226 stores a plurality of parameters and rules required for the predictive algorithm. This includes predefined weights for different data values, rules for dynamically adjusting weights based on real-time data inputs, and criteria for categorizing data values as positive or negative factors. Additionally, the Algorithm Data Storage 226 may contain historical data and trends used to refine the predictive algorithm and improve its accuracy over time.

The system 100 integrates continuous monitoring with predictive analysis to provide real-time updates to the qualifier score. As new data is received and processed by the Signal Module 204 and Data Extraction Module 206, the Score Calculation Module 212 dynamically adjusts the qualifier score based on the updated data. Each data value within the categorized record has an associated weight, and the algorithm recalculates the product of these data values and their respective weights, ensuring that the qualifier score always reflects the most current financial situation of the applicant.

The device 202 is configured to output the updated qualifier score to a platform interface accessible to users, such as applicants, lenders, or landlords. Each time new data is received and processed, the Score Calculation Module 212 dynamically updates the displayed score.

Upon receiving the qualifier score, the Score Calculation Module 212 determines whether the score falls within one or more of the predefined ranges. The predefined ranges categorize the scores into different levels of financial reliability. For example, scores between 1 to 100 can be segmented into ranges such as over 80 for a qualifier range, 60-80 for a borderline range, and less than 60 for a disqualified range. The device 202 continuously updates the score based on real-time transactions, deposits, withdrawals, and other liabilities, ensuring that the most current data is reflected in the score. Consequently, the range determination may also be dynamically updated. The Score Calculation Module 212 may also output different color coding to indicate the range to which the score belongs. For instance, scores in the qualifier range may be coded in green, borderline scores in yellow, and disqualified scores in red.

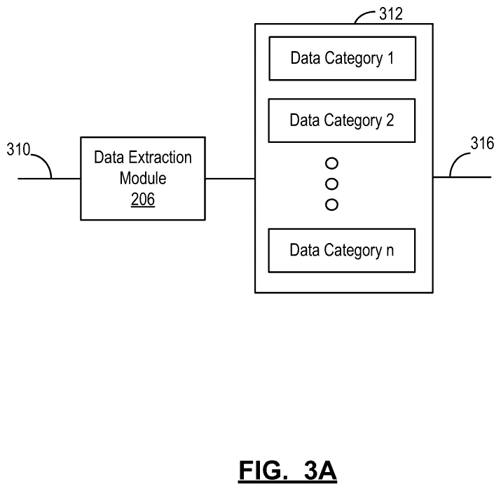

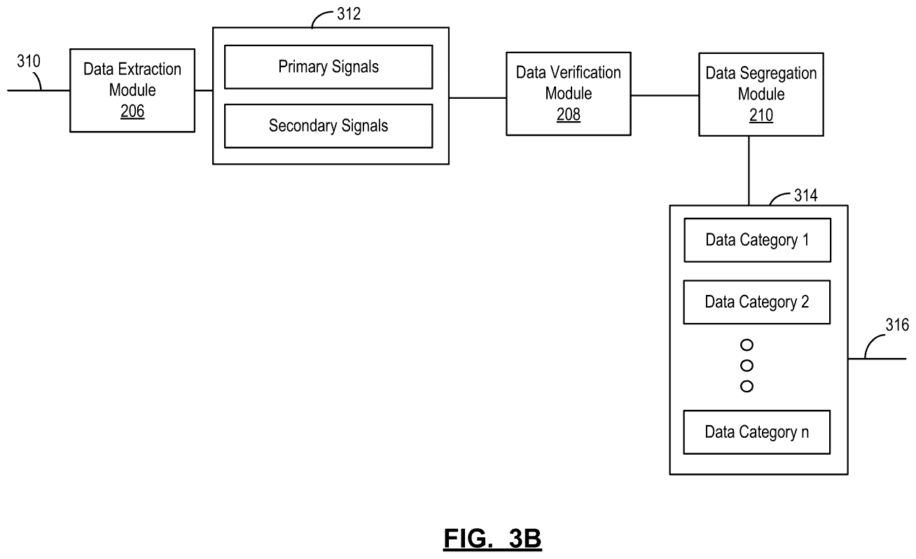

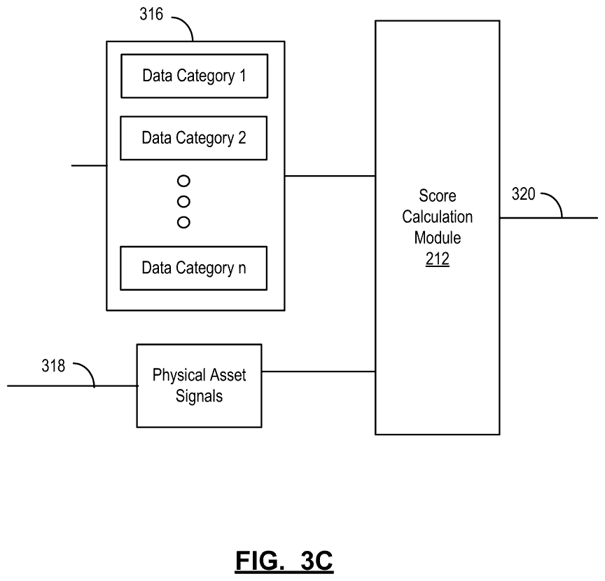

Reference is now made to FIG. 3A, which illustrates an example block diagram of a data extraction and risk assessment device 200 of FIG. 2.

The Data Extraction Module 206 receives input signals 310 in the form of the first record. The module extracts a corresponding second record by implementing a plurality of predefined tags. The Data Extraction Module 206 generates a categorized record 316 from the corresponding second record, with the categorized record including a plurality of data categories. Each data category corresponds to a predefined tag.

For example, the first record includes the following JSON file:

| | | |
|---|---|---|
| { | “logo_url”: “https://plaid- | “category_id”: |
| [ | merchant- | “22001000”, |
| { | logos.plaid.com/uber_1060.png”, | “check_number”: null, |
| “account_id”: | “merchant_entity_id”: | “counterparties”: [ |
| “6qw4zVzkLVtGRjJnQzXzf5ARkL | “eyg8o776k0QmNgVpAmaQj4Wg | { |
| 1KaAU8Q9obA”, | zW9Qzo6O51gdd”, | “confidence_level”: |
| “account_owner”: null, | “merchant_name”: “Uber”, | “VERY_HIGH”, |
| “amount”: 5.4, | “name”: “Uber 063015 | “entity_id”: |
| “authorized_date”: “2024- | SF**POOL**”, | “NKDjqyAdQQzpyeD8qpLnX0D6 |
| 04-23”, | “payment_channel”: | yvLe2KYKYYzQ4”, |
| “authorized_datetime”: | “online”, | “logo_url”: |
| null, | “payment_meta”: { | “https://plaid-merchant- |
| “category”: [ | “by_order_of”: null, | logos.plaid.com/united_airlines_{—} |
| “Travel”, | “payee”: null, | 1065.png”, |
| “Taxi” | “payer”: null, | “name”: “United |
| ], | “payment_method”: null, | Airlines”, |
| “category_id”: | “payment_processor”: | “phone_number”: |
| “22016000”, | null, | null, |
| “check_number”: null, | “ppd_id”: null, | “type”: “merchant”, |
| “counterparties”: [ | “reason”: null, | “website”: |
| { | “reference_number”: | “united.com” |
| “confidence_level”: | null | } |
| “VERY_HIGH”, | }, | ], |
| “entity_id”: | “pending”: false, | “date”: “2024-04-22”, |
| “eyg8o776k0QmNgVpAmaQj4Wg | “pending_transaction_id”: | “datetime”: null, |
| zW9Qzo6O51gdd”, | null, | “iso_currency_code”: |
| “logo_url”: | “personal_finance_category”: { | “CAD”, |
| “https://plaid-merchant- | “confidence_level”: | “location”: { |
| logos.plaid.com/uber_1060.png”, | “VERY_HIGH”, | “address”: null, |
| “name”: “Uber”, | “detailed”: | “city”: null, |
| “phone_number”: | “TRANSPORTATION_TAXIS_AN | “country”: null, |
| null, | D_RIDE_SHARES”, | “lat”: null, |
| “type”: “merchant”, | “primary”: | “lon”: null, |
| “website”: | “TRANSPORTATION” | “postal_code”: null, |
| “uber.com” | }, | “region”: null, |
| } | “personal_finance_category_icon | “store_number”: null |
| ], | _url”: “https://plaid-category- | }, |
| “date”: “2024-04-24”, | icons.plaid.com/PFC_TRANSPOR | “logo_url”: “https://plaid- |
| “datetime”: null, | TATION.png”, | merchant- |
| “iso_currency_code”: | “transaction_code”: null, | logos.plaid.com/united_airlines_{—} |
| “CAD”, | “transaction_id”: | 1065.png”, |
| “location”: { | “kleoGdGRpdFRLrmwqoGol5b3rv | “merchant_entity_id”: |
| “address”: null, | QnqbUL75193”, | “NKDjqyAdQQzpyeD8qpLnX0D6 |
| “city”: null, | “transaction_type”: | yvLe2KYKYYzQ4”, |
| “country”: null, | “special”, | “merchant_name”: |
| “lat”: null, | “unofficial_currency_code”: null, | “United Airlines”, |
| “lon”: null, | “website”: “uber.com” | “name”: “United Airlines”, |
| “postal_code”: null, | }, | “payment_channel”: “in |
| “region”: null, | { | store”, |
| “store_number”: null | “account_id”: | “payment_meta”: { |
| }, | “6qw4zVzkLVtGRjJnQzXzf5ARkL | “by_order_of”: null, |
| | 1KaAU8Q9obA”, | “payee”: null, |
| | “account_owner”: null, | “payer”: null, |
| | “amount”: −500, | “payment_method”: |
| | “authorized_date”: “2024- | null, |
| | 04-22”, | “payment_processor”: |
| | “authorized_datetime”: | null, |
| | null, | “ppd_id”: null, |
| | “category”: [ | “reason”: null, |
| | “Travel”, | “reference_number”: |
| | “Airlines and Aviation | null |
| | Services” | }, |
| | ], | “pending”: false, |
| | | “pending_transaction_id”: |
| | | null, |
| | | “personal_finance_category”: { |
| | | “confidence_level”: |
| | | “VERY_HIGH”, |
| | | “detailed”: |
| | | “TRAVEL_FLIGHTS”, |
| | | “primary”: “TRAVEL” |
| | | }, |
| | | “personal_finance_category_icon |
| | | _url”: “https://plaid-category- |
| | | icons.plaid.com/PFC_TRAVEL.p |
| | | ng”, |
| | | “transaction_code”: null, |
| | | “transaction_id”: |
| | | “lkXolalRJalyRzqQKVxVF3rNkyl |
| | | QArupB3m4z”, |
| | | “transaction_type”: |
| | | “special”, |
| | | “unofficial_currency_code”: null, |
| | | “website”: “united.com” |
| | | } |

The provided input signals are detailed financial transaction records from external systems. Each transaction entry includes comprehensive metadata that providing the transaction specifics. For instance, the first transaction is an Uber ride on Apr. 24, 2024, costing $5.40 CAD, categorized under “Travel” and “Taxi.” The record includes the merchant's name, payment channel (online), and associated metadata like merchant logos and counterparties, ensuring a high confidence level in data accuracy. Similarly, the second transaction is a purchase from United Airlines for-$500 CAD on Apr. 22, 2024, under “Travel” and “Airlines and Aviation Services,” with similar detailed metadata.

The system categorizes these transactions based on predefined tags, such as “Transportation” and “Travel.” The metadata, such as transaction date, amount, category, and merchant information, allows the system to extract and segregate data into relevant categories.

Categorized Data: Based on the sample transactions provided, the categorized data might be organized as follows:

### Transportation

### Uber Ride

Amount: $5.40 CAD
Date: 2024 Apr. 24
Category: Transportation, Taxi
Merchant: Uber
Payment Channel: Online
Description: This transaction represents a typical ride-sharing expense, indicating routine transportation costs.

### Travel

### United Airlines Purchase

Amount: −$500 CAD
Date: 2024 Apr. 22
Category: Travel, Airlines
Merchant: United Airlines
Payment Channel: In-store
Description: A significant travel expense, providing insights into discretionary spending and financial planning.

### Food and Drink

### McDonald's Purchase

Amount: $12 CAD
Date: 2024 Apr. 21
Category: Food and Drink, Fast Food
Merchant: McDonald's
Payment Channel: In-store
Description: Frequent fast-food transactions may indicate spending habits and budget management.

### Starbucks Coffee Purchase

Amount: $4.33 CAD
Date: 2024 Apr. 21
Category: Food and Drink, Coffee Shop
Merchant: Starbucks
Payment Channel: In-store
Description: Routine coffee purchases can reflect daily spending routines and discretionary expenses.

The categorized data allows the device 200 to efficiently analyze spending patterns, evaluate financial behaviors, and generate accurate risk assessments for users, such as applicants, lenders, or landlords.

In another example, the first record includes the following JSON file:

| | | |
|---|---|---|
| “credit”: [ | “mortgage”: [ | “expected_payoff_date |
| { | { | ”: “2032-07-28”, |
| “account_id”: | “account_id”: | “guarantor”: “DEPT |
| “bZXAWNXVqqTAKjVDPJIvTz9ZxME | “RqMNDkMg99TN1woMJkBIH7kj5G9r | OF ED”, |
| wkZtmvv1kp”, | Ljta11Wq9”, | “interest_rate_percenta |
| “aprs”: [ | “account_number”: “3120194154”, | ge”: 5.25, |
| { | “current_late_fee”: 25, | “is_overdue”: false, |
| “apr_percentage”: 15.24, | “escrow_balance”: 1200, | “last_payment_amount |
| “apr_type”: | “has_pmi”: true, | ”: 138.05, |
| “balance_transfer_apr”, | “has_prepayment_penalty”: true, | “last_payment_date”: |
| “balance_subject_to_apr”: | “interest_rate”: { | “2019-04-22”. |
| 1562.32, | “percentage”: 3.99, | “last_statement_balanc |
| “interest_charge_amount”: | “type”: “fixed” | e”: 138.05, |
| 130.22 | } | “last_statement_issue_{—} |
| }, | “last_payment_amount”: 3141.54, | date”: “2019-04-28”, |
| { | “last_payment_date”: “2019-08- | “loan_name”: |
| “apr_percentage”: 27.95, | 01”, | “Consolidation”, |
| “apr_type”: “cash_apr”. | “loan_term”: “30 year”, | “loan_status”: { |
| “balance_subject_to_apr”: | “loan_type_description”: | “end_date”: |
| 56.22, | “conventional”, | “2032-07-28”, |
| “interest_charge_amount”: | “maturity_date”: “2045-07-31”, | “type”: |
| 14.81 | “next_monthly_payment”: 3141.54, | “repayment” |
| }, | “next_payment_due_date”: “2019- | }, |
| { | 11-15”, | “minimum_payment_a |
| “apr_percentage”: 12.5, | “origination_date”: “2015-08-01”, | mount”: 25, |
| “apr_type”: “purchase_apr”, | “origination_principal_amount”: | “next_payment_due_d |
| “balance_subject_to_apr”: | 425000, | ate”: “2019-05-28”, |
| 157.01, | “past_due_amount”: 2304, | “origination_date”: |
| “interest_charge_amount”: | “property_address”: { | “2002-08-28”, |
| 25.66 | “city”: “Malakoff”, | “origination_principal_a |
| }, | “country”: “US”, | mount”: 25000, |
| { | “postal_code”: “14236”, | “outstanding_interest_a |
| “apr_percentage”: 0, | “region”: “NY”, | mount”: 6227.36, |
| “apr_type”: “special”, | “street”: “2992 Cameron Road” | “payment_reference_n |
| “balance_subject_to_apr”: 1000, | }, | umber”: “4277075694”, |
| “interest_charge_amount”: 0 | “ytd_interest_paid”: 12300.4, | “pslf_status”: { |
| } | “ytd_principal_paid”: 12340.5 | “estimated_eligibility_d |
| ], | } | ate”: “2021-01-01”, |
| “is_overdue”: false, | ], | “payments_made”: |
| “last_payment_amount”: 168.25, | “student”: [ | 200, |
| “last_payment_date”: “2019-05- | { | “payments_remaining”: |
| 22” | “account_id”: | 160 |
| “last_statement_balance”: | “vvDjnmDVkkhednv8jQmBIW4Mb8RL | }, |
| 1708.77, | BMSq77BKj”, | “repayment_plan”: { |
| “last_statement_issue_date”: | “account_number”: “4277075694”, | “description”: |
| “2019-05-28”, | “disbursement_dates”: [ | “Standard Repayment”, |
| “minimum_payment_amount”: 20, | “2002-08-28” | “type”: “standard” |
| “next_payment_due_date”: “2020- | ], | }, |
| 05-28” | | “sequence_number”: |
| } | | “1”, |
| ], | | “servicer_address”: |
| | | { |
| | | “city”: “San |
| | | Matias”, |
| | | “country”: “US”, |
| | | “postal_code”: |
| | | “99415”, |
| | | “region”: “CA”, |
| | | “street”: “123 |
| | | Relaxation Road” |
| | | } |
| | | “ytd_interest_paid”: |
| | | 280.55, |
| | | “ytd_principal_paid”: |
| | | 271.65 |
| | | } |
| | | ] } |

The Data Extraction Module 206 is configured for processing and categorizing input signals to create a structured dataset.

In the present example, the credit account details include comprehensive information about various APRs, last payment amounts, minimum payment requirements, and upcoming payment due dates. The data is categorized under liability categories, reflecting the applicant's credit usage and payment behavior. Similarly, the mortgage account details provide data values on applicant's long-term financial commitments, such as loan types, interest rates, payment schedules, and outstanding principal amounts. The data values are categorized under asset and liability categories. The student loan details include loan types, interest rates, payment histories, and expected payoff dates, categorized under liability categories to highlight the applicant's educational debts and repayment status.

### Credit Account Details:

Account ID: bZXAWNXVqqTAKjVDPJIvTz9ZxMEwkZtmvv1kp
APRs:
Balance Transfer APR: 15.24% on $1562.32 with an interest charge of $130.22
Cash APR: 27.95% on $56.22 with an interest charge of $14.81
Purchase APR: 12.5% on $157.01 with an interest charge of $25.66
Special APR: 0% on $1000 with no interest charge
Last Payment: $168.25 on 2019 May 22
Next Payment Due Date: 2020 May 28
Minimum Payment Amount: $20
Mortgage Account Details:
Account ID: RqMNDKMg99TN1woMJkBIH7kj5G9rLjta11Wq9
Property Address: 2992 Cameron Road, Malakoff, NY, 14236, US
Loan Type: Conventional, 30-year term
Interest Rate: 3.99% (fixed)
Next Monthly Payment: $3141.54 due on 2019 Nov. 15
Outstanding Principal: Initially $425,000

### Student Loan Details:

Account ID: vvDjnm DVkkhednv8jQmBIW4Mb8RLBMSq77BKj
Loan Name: Consolidation
Interest Rate: 5.25%
Origination Date: 2002 Aug. 28
Expected Payoff Date: 2032 Jul. 28
Last Payment: $138.05 on 2019 Apr. 22
Next Payment Due Date: 2019 May 28

Reference is now made to FIG. 3B, which illustrates an example block diagram of a data extraction and risk assessment device 200 of FIG. 2, according to an embodiment.

The Data Extraction Module 206 receives input signals 310. The input signals are received from multiple external systems, including primary systems with high data credibility and secondary systems with less direct validation.

Upon receiving these input signals, the Data Extraction Module 206 processes and extracts a first record 312. This first record 312 comprises both primary signals and secondary signals.

The first record 312 is then transmitted to the Data Verification Module 208. Within the module 208, subsets of the primary and secondary signals are evaluated against each other to check for consistency and accuracy.

If a verified signal is received from the Data Verification Module 208, indicating that the primary and secondary signals have been successfully matched and verified, the primary signals are sent to the Data Segregation Module 210. Here, the primary signals are segmented into a categorized record 314. The Data Segregation Module 210 breaks down the verified first record into multiple data categories, each corresponding to predefined tags.

Reference is now made to FIG. 3C, which illustrates an example block diagram of a data extraction and risk assessment device 200 of FIG. 2, according to an embodiment.

The physical asset signals are received from the Signal Module 204. The categorized record 316 and the physical asset signals 318 are transmitted to the Score Calculation Module 212. Within the Score Calculation Module 212, the predictive algorithm operates by assigning a plurality of weights to various data values within each data category. The weights are predefined but can be dynamically adjusted based on real-time data and administrative policies. The categorized record 316, which includes data categories such as income, liabilities, assets, and credit activities, is processed by evaluating each data value and its assigned weight.

The predictive algorithm in the Score Calculation Module 212 calculates a qualifier score by distinguishing between positive and negative factors within the data categories. Positive factors, such as high credit scores, substantial income, consistent employment history, and significant down payments, are assigned higher weights. Conversely, negative factors, including high outstanding liabilities, previous defaults, and high debt-to-income ratios, are assigned negative weights.

In another example, the Data Extraction Module 206 is configured for processing an input signal comprising an asset data report in JSON format to verify an applicant's readiness regarding their down payment for a new construction unit. The predictive algorithm analyzes the applicant's existing financial data extracted from the input signals to determine whether the down payment is complete or only partial. If only a portion of the down payment is available, the Score Calculation Module 212 projects whether the applicant is on track to accumulate the required amount before the deadline to apply for a mortgage. This projection is based on the applicant's income schedule and the timeline until the construction unit is ready to be closed upon. The respective data points are derived from the transactions report or the input signals. For instance, if an applicant has secured 15% of the required 20% for an insurable or uninsurable mortgage, the Score Calculation Module 212 evaluates their income against their expenses to predict if they can save up the full 20% by the closing date. In the present example, the input signals received as a JSON file include:

```
{
  “assets_report”: {
    “applicant_id”: “123456”,
    “current_down_payment”: 15000,
    “required_down_payment”: 20000,
    “income_schedule”: [
      {“month”: “June”, “income”: 5000},
      {“month”: “July”, “income”: 5200},
      {“month”: “August”, “income”: 5400}
    ],
    “projected_savings”: 18000,
    “closing_date”: “2024-09-01”
  }
```

The resulting categorized data as returned by the Data Extraction Module 206 include:

### Assets Category:

Current Down Payment: $15000
Required Down Payment: $20000
Income Schedule:
June: $5000
July: $5200
August: $5400
Projected Savings: $18000
Closing Date: 2024 Sep. 1

In another example, the Data Extraction Module 206 extracts a liabilities report in JSON format to examine each tradeline. The data values indicate the relevant liabilities held under the applicant's name for calculating the Total Debt Service Ratio (TDSR) and Gross Debt Service Ratio (GDSR). The ratios are directed to various lending guidelines, whether liabilities are insured, insurable, or uninsurable. By parsing each tradeline for minimum monthly payments, outstanding balances, and other pertinent data, the Score Calculation Module 212 automates the computation of debt service ratios, streamlining the financial vetting process. In the present example, the input signals received as a JSON file include:

```
{
  “liabilities_report”: {
    “applicant_id”: “123456”,
    “tradelines”: [
      {“type”: “credit_card”, “outstanding_balance”: 5000,
      “minimum_payment”: 150},
      {“type”: “student_loan”, “outstanding_balance”: 20000,
      “minimum_payment”: 200}
    ],
    “TDSR”: 36,
    “GDSR”: 28
}
```

The resulting categorized data as returned by the Data Extraction Module 206 include:

### Liabilities Category

Credit Card:
Outstanding Balance: $5000
Minimum Payment: $150
Student Loan:
Outstanding Balance: $20000
Minimum Payment: $200
TDSR: 36%
GDSR: 28%

In another example, the Data Extraction Module 206 is configured for processing an input signal comprising a transactions report in JSON format to assess deposit transactions, enabling the determination of an individual's actual income. The analysis includes tracking income sources over a predetermined period. For example, the predetermined period may be three months for employed individuals and two years for self-employed. In the present example, the input signals received as a JSON file include:

```
{
  “transactions_report”: {
    “applicant_id”: “123456”,
    “transactions”: [
      {“date”: “2024-06-01”, “type”: “deposit”, “amount”: 5000,
      “source”: “employer”},
      {“date”: “2024-06-15”, “type”: “deposit”, “amount”: 2500,
      “source”: “side_job”}
    ],
    “average_monthly_income”: 3750
  }
```

The resulting categorized data as returned by the Data Extraction Module 206 include:

### Income Category

Transaction:
Date: 2024 Jun. 1
Type: Deposit
Amount: $5000
Source: Employer
Transaction:
Date: 2024 Jun. 15
Type: Deposit
Amount: $2500
Source: Side Job
Average Monthly Income: $3750

The calculation of the qualifier score involves aggregating the weighted data values of positive factors and subtracting the cumulative weighted data values of negative factors. The final qualifier score is then displayed on a platform interface accessible to users such as applicants, lenders, or landlords.

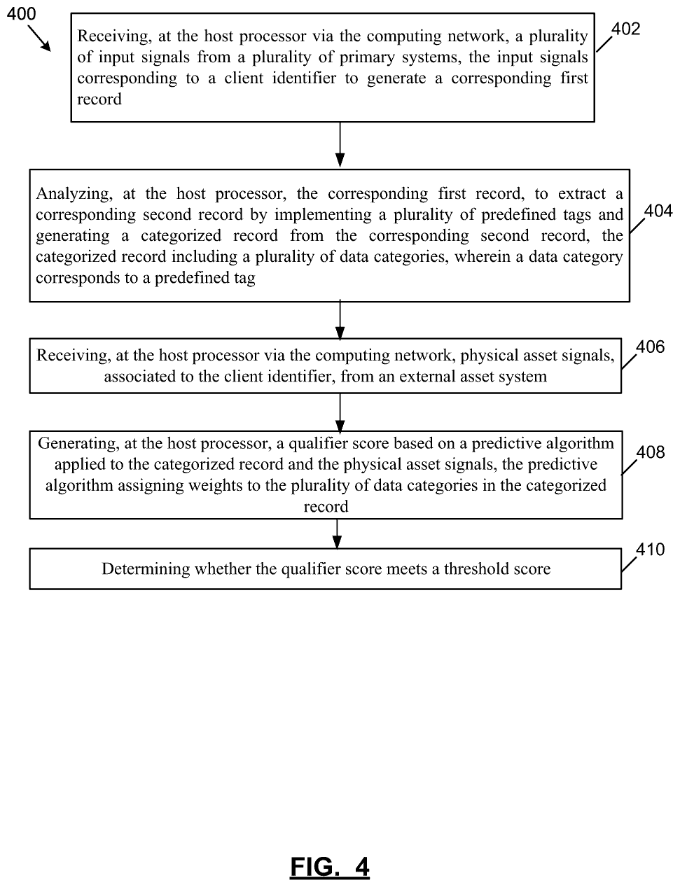

Reference is now made to FIG. 4, which shows a flowchart 400 of an example method for processing financial data to generate a qualifier score according to an embodiment. The method 400 can be implemented by the host processor 112 of the Score Estimation Device 104 of FIG. 1.

At 402, the method includes receiving, at the host processor via the computing network, a plurality of input signals from a plurality of external systems, to generate a corresponding first record. The input signals correspond to a client identifier.

The host processor receives input signals from multiple external systems. The external systems include high-credibility primary sources such as banking systems, credit bureaus, and tax authorities. The input signals are linked to a unique client identifier, providing that all data corresponds accurately to the correct individual. This data includes various financial details such as transaction logs, account statements, income records, credit activities, and more. The input signals may comprise of raw data formats such as JSON, XML, or CSV. Upon receiving these input signals, the host processor generates a first record.

At 404, the method includes analyzing, at the host processor, the corresponding first record, to extract a corresponding second record by implementing a plurality of predefined tags and generating a categorized record from the corresponding second record, the categorized record including a plurality of data categories, wherein a data category corresponds to a predefined tag.

The host processor analyzes the first record. The process includes implementing predefined tags to identify and isolate relevant pieces of information within the first record. The predefined tags are configured to capture specific types of data, such as income, liabilities, and transaction histories. By using these tags, the host processor extracts the relevant data points required for further processing.

Once the relevant data is extracted, the host processor generates a second record. Simultaneously, the host processor generates a categorized record from the second record. The categorized record includes multiple data categories, each corresponding to a predefined tag. Data categories may include asset categories, liability categories, income categories, and credit activity categories. Each category is populated with relevant data points extracted from the first record.

At 406, the method includes receiving, at the host processor via the computing network, physical asset signals, associated with the client identifier, from an external asset system.

The host processor receives physical asset signals. The physical asset signals are associated with the client identifier. The physical asset signals are transmitted from an external asset system. This system provides data related to the property intended to be purchased or rented. The physical asset signals include information such as property value, location data, transaction date, rental value, down payment, and rental deposit.

At 408, the method includes generating, at the host processor, a qualifier score based on a predictive algorithm applied to the categorized record and the physical asset signals, the predictive algorithm assigning weights to the plurality of data categories in the categorized record.

The host processor generates a qualifier score by applying a predictive algorithm to both the categorized record and the physical asset signals. The predictive algorithm assigns specific weights to each of the data categories within the categorized record. The weights reflect the relative importance of each data category in the overall risk assessment. The algorithm evaluates a plurality of factors in the categorized record, such as income, liabilities, credit activities, and transaction histories, along with the physical asset signals that include property-related data.

By calculating the weighted values of these data categories, the predictive algorithm generates a qualifier score. The qualifier score provides a comprehensive measure of the client's financial reliability and ability to fulfill financial commitments related to the property transaction. The qualifier score can be used to determine the client's eligibility and risk profile.

At 410, the method includes determining whether the qualifier score meets one or more threshold ranges.

The host processor evaluates the generated qualifier score to determine if it meets predefined threshold ranges. The threshold ranges are established to categorize the financial reliability of the client. For example, the thresholds may define ranges such as high reliability, moderate reliability, and low reliability. The host processor compares the qualifier score against these predefined ranges to classify the client's financial status. If the score falls within the high reliability range, the score indicates strong financial health and low risk. Conversely, if the score is in the low reliability range, the score suggests potential financial instability and higher risk.

In an embodiment, the method includes normalizing, at the host processor, the plurality of data categories based on a sufficiency factor. The sufficiency factor provides a completeness check on the plurality of data categories by comparing the plurality of data categories to a plurality of weighted fields to determine a missing data value. Upon determining the missing data value, a null value is entered into the missing data value in the plurality of data categories.

The host processor normalizes the data categories within the categorized record using a sufficiency factor. This sufficiency factor is a metric designed to verify the completeness and accuracy of the data categories. The host processor compares each data category in the categorized record against a set of weighted fields defined by the sufficiency factor. Each weighted field represents an essential data point required for accurate predictive analysis. During this comparison, if the host processor identifies a missing data value, the host processor takes appropriate action to address this gap. Specifically, if the corresponding data value cannot be retrieved from any secondary sources, the host processor enters a null value into the missing data field.

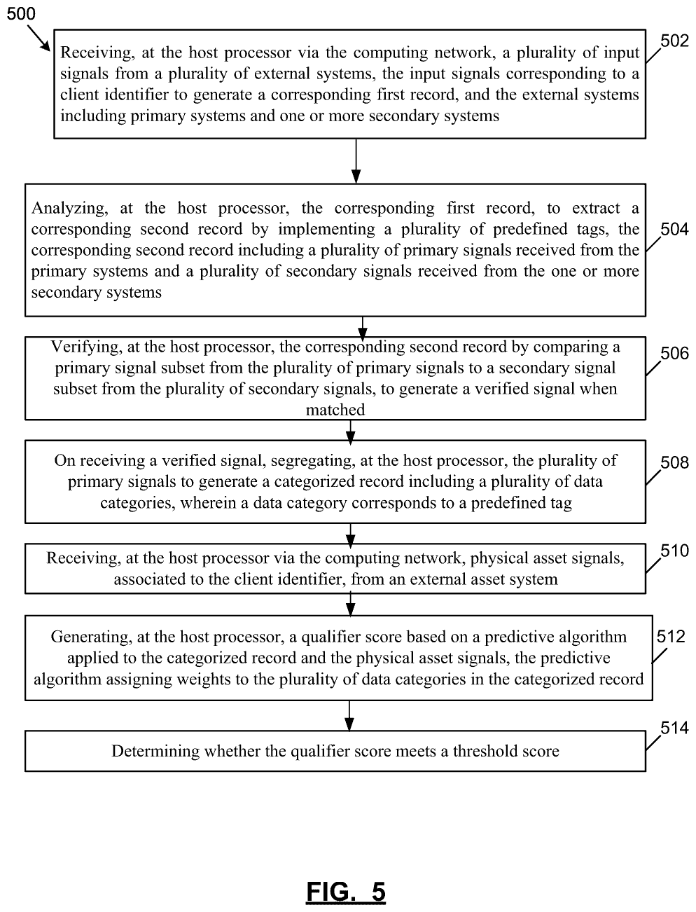

Reference is now made to FIG. 5, which shows a flowchart 500 of an example method for processing financial data to generate a qualifier score according to an embodiment. The method 500 can be implemented by the host processor 112 of the Score Estimation Device 104 of FIG. 2.

At 502, the method includes receiving, at the host processor via the computing network, a plurality of input signals from a plurality of external systems, the input signals corresponding to a client identifier to generate a corresponding first record, and the external systems including primary systems and one or more secondary systems.

The host processor receives input signals from multiple external systems. The external systems include high-credibility primary systems such as banking systems, credit bureaus, and tax authorities, and secondary systems such as client-provided data and personal references. The input signals are linked to a unique client identifier.

At 504, the method includes analyzing, at the host processor, the corresponding first record, to extract a corresponding second record by implementing a plurality of predefined tags, the corresponding second record including a plurality of primary signals received from the primary systems and a plurality of secondary signals received from the one or more secondary systems.

The host processor analyzes the first record by implementing predefined tags designed to identify and isolate relevant information. The predefined tags identify data types, including income, liabilities, and transaction histories. By utilizing the predefined tags, the host processor extracts the relevant data points for further processing. Once the relevant data is extracted, the host processor generates a second record that a plurality of primary signals from the primary systems and a plurality of secondary signals from the secondary systems.

At 506, the method includes verifying, at the host processor, the corresponding second record by comparing a primary signal subset from the plurality of primary signals to a secondary signal subset from the plurality of secondary signals, to generate a verified signal when matched.

The host processor verifies the second record by comparing a subset of data from the primary signals against a corresponding subset from the secondary signals. The verification process includes selecting representative data points or subsets from both primary and secondary signals. By matching the subsets, the host processor can generate a verified signal, indicating that the data from the primary and secondary sources are consistent.

At 508, the method includes on receiving a verified signal, segregating, at the host processor, the plurality of primary signals to generate a categorized record including a plurality of data categories, wherein a data category corresponds to a predefined tag.

Upon receiving a verified signal, the host processor segregates the primary signals to generate a categorized record. This categorized record includes a plurality of data categories, each corresponding to a predefined tag. Data categories may include asset categories, liability categories, income categories, and credit activity categories. Each category is populated with relevant data points extracted from the primary signals.

At 510, the method includes receiving, at the host processor via the computing network, physical asset signals, associated with the client identifier, from an external asset system.

The host processor receives physical asset signals linked to the client identifier from an external asset system. These signals provide data related to the property intended for purchase or rental.

At 512, the method includes generating, at the host processor, a qualifier score based on a predictive algorithm applied to the categorized record and the physical asset signals, the predictive algorithm assigning weights to the plurality of data categories in the categorized record.

The host processor generates a qualifier score by applying a predictive algorithm to the categorized record and the physical asset signals. The predictive algorithm assigns specific weights to each data category within the categorized record. The algorithm provides a qualifier score that reflects the applicant's financial reliability and ability to meet financial commitments related to the property transaction.

At 514, the method includes determining whether the qualifier score meets one or more threshold ranges.

The host processor evaluates the generated qualifier score against predefined threshold ranges to categorize the client's financial reliability. The thresholds provide ranges such as high reliability, moderate reliability, and low reliability.

In an embodiment, the method includes normalizing, at the host processor, the plurality of data categories based on a sufficiency factor. The sufficiency factor is a metric designed to verify the completeness and accuracy of the data categories. The host processor compares each data category in the categorized record against a plurality of weighted fields defined by the sufficiency factor. Each weighted field represents an essential data point required for accurate predictive analysis.

The sufficiency factor provides a completeness check on the plurality of data categories by comparing the plurality of data categories to a plurality of weighted fields to determine a missing data value. If the host processor determines that a data value is missing, the host processor takes appropriate action to address this gap. When a corresponding data value is available in the plurality of secondary signals, the host processor retrieves and enters the corresponding data value from the secondary signals into the missing data value in the relevant data category.

On determining the missing data value, if the corresponding data value is unavailable in the plurality of secondary signals, the host processor enters a null value into the missing data value within the relevant data category. This normalization process provides that all data categories are standardized and that any missing data is explicitly marked, thus avoiding potential inaccuracies in the risk assessment.

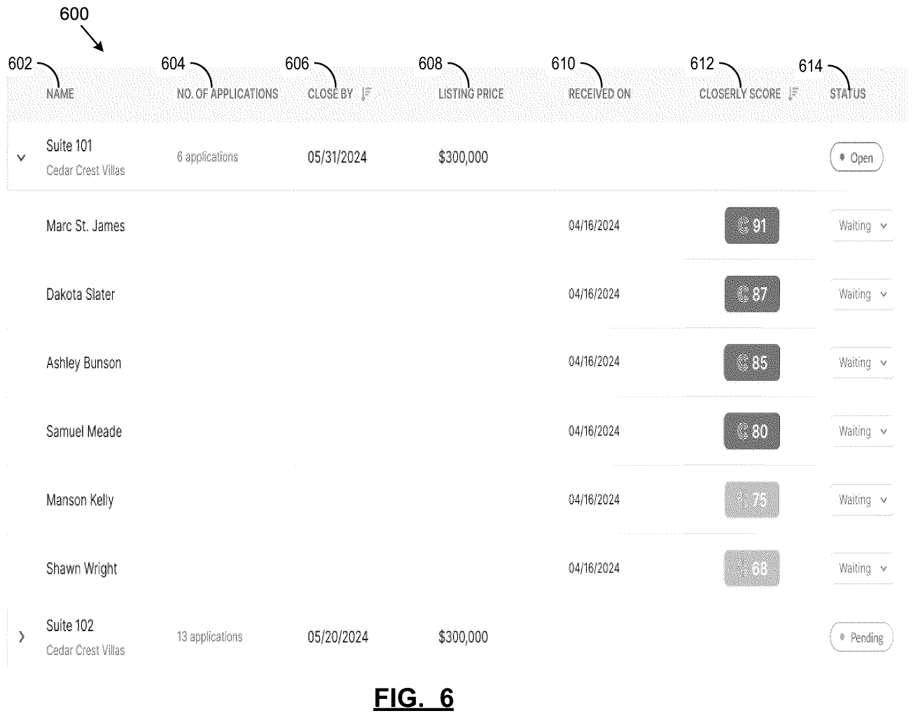

Reference is now made to FIG. 6, which shows a screen view 600 of an interface connected to a data extraction and risk assessment system 100, according to an embodiment. The interface can be implemented by the host processor 112 of the Score Estimation Device 104 of FIG. 1.

The Score Estimation Device 104 is configured to provide an interface viewable from the user terminal 106. The interface can display detailed information regarding property applications and applicant scores. The interface, as shown in FIG. 6, can provide a user-friendly and organized presentation of backend operations performed by the Score Estimation Device 104. For example, the interface allows users, such as builders, to gauge interest and monitor the financial risk of the potential buyers effectively. Additionally, the interface is configured to receive user inputs.

The Score Estimation Device 104 can generate the interface by processing data from multiple external systems using secure APIs, which continuously update the categorized records and calculate qualifier scores based on real-time data inputs. The processed data can be then formatted into a structured view and transmitted to the user terminal 106, where it is rendered as an interactive interface. This interface allows users to not only view real-time updates on application statuses, scores, and other relevant details but also input new data and make updates as necessary.

Different types of interfaces can be provided based on user requirements:

Applicant Interface: The applicant interface allows mortgage or tenancy applicants to submit their application data, view their application status, and monitor their qualifier scores. The interface provides a detailed view of their financial data, allowing them to understand the factors affecting their score and make necessary updates or corrections to their application information.

Bank Interface: The bank interface is designed for financial institutions to access and review the financial status of applicants. Banks can use this interface to verify applicant information, assess risk levels, and make informed decisions regarding loan approvals. In one embodiment, financial institutions rely on the qualifier scores discussed here to make mortgage lending decisions for real estate developers and builders for new construction. The interface provides detailed insights into each applicant's financial health, credit activities, and transaction histories.

Builder Interface: Builders can use this interface to track the progress of property sales and monitor the status of potential buyers' applications. The interface allows builders to view aggregated data on applicant scores, the number of applications received, and other relevant metrics, helping them manage sales pipelines effectively.

Property Manager Interface: Property managers can utilize this interface to oversee rental applications and tenant qualifications. The property manager interface provides real-time updates on tenant financial stability, rental payment histories, and risk assessments, enabling property managers to make informed decisions on tenant approvals and manage properties efficiently.

Various other interface designs and configurations are possible, each tailored to meet specific user requirements and operational contexts.

The embodiment in FIG. 6 shows a configuration of the builder interface, where different components of the data extraction and risk assessment system are integrated seamlessly.

The builder interface provides for tracking the financial risk of potential buyers for “Cedar Crest Villas Suite 101”. The “Name” column 602 lists the names of potential buyers of the property and tracks their qualifier scores. The potential buyers are listed as “Marc St. James”, “Dakota Slater”, “Ashley Bunson”, “Samuel Meade”, “Manson Kelly”, and “Shawn Wright”. The Name column 602 allows builders to quickly identify and differentiate between applicants. Each name entry is associated with detailed financial data and risk assessment metrics, enabling the builder to evaluate each applicant's financial stability and qualification status effectively. By integrating real-time data and providing a clear overview of all applicants, the solution enhances the builder's ability to make informed decisions regarding property sales.

The “No. of Applications” column 604 tracks the total number of potential buyers whose financial risks are being assessed. For Suite 101, there are six applications, indicating that six applicants' financial data and risk metrics are monitored and analyzed. The 604 column enables builders understand the level of interest in the property, and the number of potential transactions under consideration. The Score Estimation Device 104 compiles and updates this data in real-time, and provides that the builder has the latest information on the number of active applicants.

The “Close By” date column 606 displays the transaction closing date, which is the date by which the sale is expected to be finalized. For Suite 101, the closing date is May 31, 2024. The 606 column indicates that the financial data and risk assessments for the applicants are continuously updated until the specified closing date. The Score Estimation Device 104 dynamically refreshes the applicants' financial information and integrates new data to maintain up-to-date and accurate risk evaluations. The continuous update process includes real-time financial events such as new transactions, changes in account balances, and updated credit activities. The closing date is a threshold period for the Score Estimation Device 104 to gather and analyze all relevant financial data, ensuring a comprehensive risk assessment.

The “Listing Price” column 608 shows the price at which the property is listed, which is $300,000 in the present embodiment. The price is included in the physical asset signals received by the Score Estimation Device 104. The physical asset signals include property value (listing price), location, and transaction date. The listing price is one of the factors considered by the predictive algorithm calculations. The listing price provides a basis for determining the overall financial commitment required from the buyer.

The “Received On” date column 610 indicates the date on which each applicant submitted their interest to purchase the property. For all applicants listed, the interest was received on Apr. 16, 2024. The “Received On” date (or submission date) initiates the tracking timeline of each application. The submission date provides for determining the applicant's financial position at the time of application.

The “Closely Score” column 612 displays the qualifier score for each applicant, which is a risk assessment metric generated by the predictive algorithm executed by the Score Estimation Device 104. The qualifier score evaluates the financial stability and risk profile of each applicant based on factors such as income, liabilities, credit activities, and transaction histories. The predictive algorithm dynamically assigns weights to these factors and calculates the overall score, providing a comprehensive assessment of each applicant's financial reliability. The interface features a color-coded blob alongside the score for quick visual reference: green for high scores indicating low risk (e.g., Marc St. James-91), yellow for moderate scores suggesting medium risk (e.g., Manson Kelly-75), and other colors as necessary to denote different risk levels. This visual coding enables builders quickly identify the most qualified applicants and prioritize their engagement accordingly.

The “Status” column 614 indicates the current status of each applicant's mortgage application. The 614 column provides a dropdown menu for easy status updates, allowing the builder to manage and track the progress of each application efficiently. The initial status for all applicants is marked as “Waiting,” indicating that the applications are under review. The status can be dynamically updated to reflect changes such as “Approved,” “Rejected,” or “Pending Further Information.” By offering real-time status updates, the interface ensures that builders can monitor the application lifecycle, streamline communication with applicants, and make timely decisions based on the latest information.

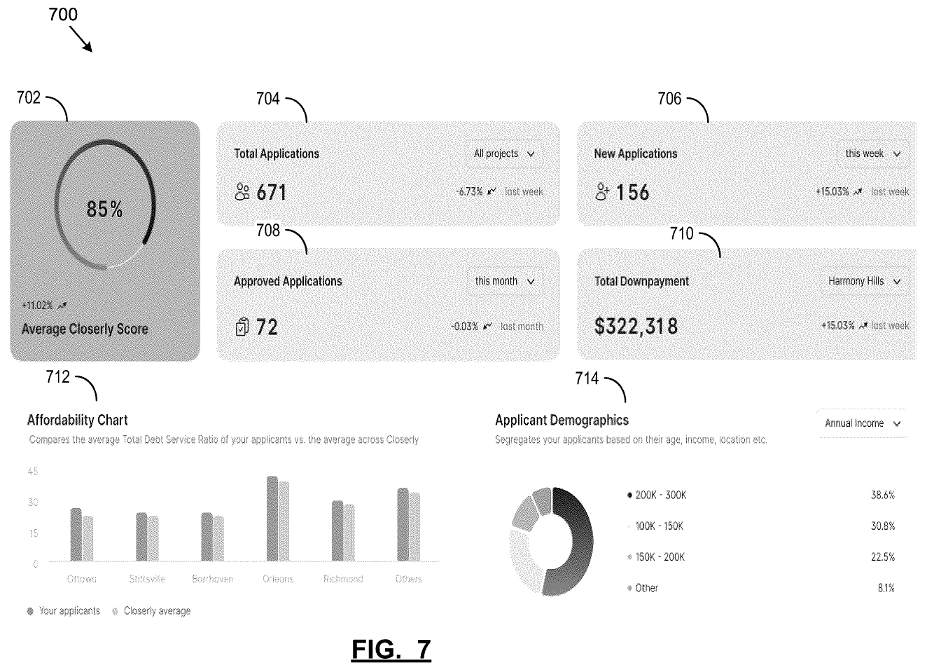

Reference is now made to FIG. 7, which shows a screen view 700 of an interface connected to a data extraction and risk assessment system 100, according to an embodiment. The interface can be implemented by the host processor 112 of the Score Estimation Device 104 of FIG. 1.

The screen view 700 provides a comprehensive overview of multiple metrics and data points related to the financial risk assessment and application status of potential buyers.

The builder interface provides for tracking the financial risk of potential buyers for “Cedar Crest Villas Suite 101.” The “Average Closely Score” section 702 displays an aggregated qualifier score represented as a percentage, which is 85% in the present embodiment case. The average score indicates the average financial stability and risk profile of all applicants across the project. The Score Estimation Device 104 calculates this score using a predictive algorithm that processes various financial data inputs, such as income, liabilities, credit activities, and transaction histories, from multiple applicants. By continuously updating these data inputs through secure APIs, the Device 104 provide real-time accuracy and relevance of the score. The average score is then derived by aggregating individual qualifier scores, applying weighted factors to different financial metrics, and normalizing the data to reflect a comprehensive risk assessment. The average score metric enables builders to receive a quick overview of the overall financial health of the applicant pool.

The builder interface provides for tracking the financial risk of potential buyers for “Cedar Crest Villas Suite 101.” The “Total Applications” section 704 displays the total number of applications received, which is 671 in the present embodiment. The total applications metric provides the level of interest and demand for the target property. The Score Estimation Device 104 compiles this data by aggregating the number of applications submitted through the system 100. Each application is logged and tracked in real-time, providing an up-to-date count. The Score Estimation Device 104 also tracks changes in the number of applications over time, allowing for trend analysis and forecasting.

The “New Applications” section 706 indicates the number of new applications received within a specified time frame, which is 156 for the present embodiment week. The new applications metric enables monitoring recent activity and interest in the property. The Score Estimation Device 104 continuously updates the new applications metric by processing incoming applications through secure APIs. Each new application is timestamped and added to the Score Estimation Device 104, for accurate and timely tracking. The Score Estimation Device 104 also compares the number of new applications to previous periods, providing insights into trends and patterns in buyer interest.

The “Approved Applications” section 708 displays the number of applications that have been approved within a specified period, which is 72 for a month in the present embodiment. The approved applications metric enables assessing the success rate of applications and the quality of applicants. The Score Estimation Device 104 generates the approved applications metric by evaluating each application against predefined criteria using a predictive algorithm. The algorithm analyzes various financial data points and assigns a qualifier score to determine approval status. Approved applications are then logged and tracked, providing a clear overview of the number of successful applicants.

The “Total Downpayment” section 710 displays the aggregated downpayment amount for all applications, which is $322,318 in the present embodiment. The aggregated downpayment metric enables builders assess the total financial commitment from applicants across the project. The dropdown menu associated with the aggregated downpayment metric provides for the selection of specific properties, enabling a detailed view of downpayments for different listings. The Score Estimation Device 104 captures and updates the aggregated downpayment metric by processing financial information from each application through secure APIs. The Device 104 logs each downpayment amount and aggregates these figures to provide a comprehensive total. Additionally, the Device 104 tracks trends over time, comparing current data with previous periods to identify changes in buyer behavior and financial capability.

The “Affordability Chart” section 712 compares the average Total Debt Service Ratio (TDSR) of applicants to the average across the platform. The chart visually represents the financial burden of debt relative to income for applicants from different locations such as Ottawa, Stittsville, Barrhaven, Orleans, Richmond, and others. The Score Estimation Device 104 generates the relative data by calculating the TDSR for each applicant based on their income and total debt obligations. The Device 104 then aggregates these ratios to determine the average TDSR for the builder's applicants and compares it with the platform's average.

The “Applicant Demographics” section 714 segregates applicants based on various factors such as age, income, and location. The visual representation enables builders understand the composition of their applicant pool. The Score Estimation Device 104 processes demographic data from each application, categorizing applicants into different segments. For instance, income categories might include ranges such as $200K $300K, $100K-$150K, $150K-$200K, and others. The Device 104 dynamically updates this information as new applications are received, providing that the demographic breakdown remains current.

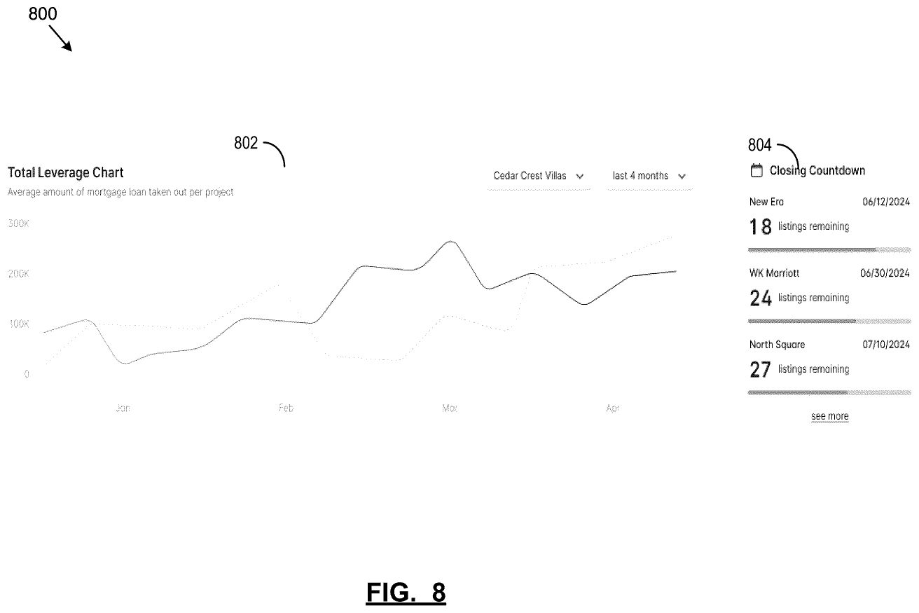

Reference is now made to FIG. 8, which shows a screen view 800 of an interface connected to a data extraction and risk assessment system 100, according to an embodiment. The interface can be implemented by the host processor 112 of the Score Estimation Device 104 of FIG. 1.

The screen view 800 provides a comprehensive overview of the average mortgage loan amounts and the countdown to the closing dates for various projects.

The “Total Leverage Chart” 802 displays the average amount of mortgage loan taken out per project, providing an essential metric for understanding the financial leverage of buyers across different periods. The chart tracks these amounts over a selected timeframe, which in the present embodiment is the last four months for the “Cedar Crest Villas” project. The Score Estimation Device 104 generates the chart by aggregating and analyzing data from multiple mortgage applications, calculating the average loan amounts based on real-time financial inputs. The dynamic chart updates continuously as new data is processed, allowing builders to monitor trends in mortgage borrowing. The solid line represents the actual average mortgage amounts, while the dashed line could represent a comparison baseline or projected trend.

The “Closing Countdown” 804 section provides a real-time overview of the remaining listings and their respective closing dates for various projects. In this instance, the interface displays the number of listings remaining for three projects: New Era with 18 listings closing on Jun. 12, 2024, WK Marriott with 24 listings closing on Jun. 30, 2024, and North Square with 27 listings closing on Jul. 10, 2024. The Score Estimation Device 104 updates the information by continuously tracking the status of each listing, integrating data from the application submissions and sales records through secure APIs. The feature provides a progress bar to visually indicate the proportion of remaining listings relative to the total, helping builders manage sales timelines and prioritize efforts to close sales before the deadlines.

The above interfaces are one of the outputs of the disclosed systems, devices, and methods. Any other implementation can be provided, and it is not limited to the specific implementation described. Further, the technical processes in the background, as detailed in other parts of this document, should be read in coherence while noting the technical improvements and efficiency achieved in the disclosed systems, devices, and methods.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A computer-implemented method, performed by a host processor via a computing network, comprising:
receiving, at the host processor via the computing network, a plurality of input signals from a plurality of external systems, the input signals corresponding to a client identifier to generate a corresponding first record, and the external systems including primary systems and one or more secondary systems;
analyzing, at the host processor, the corresponding first record, to extract a corresponding second record by implementing a plurality of predefined tags, the corresponding second record including a plurality of primary signals received from the primary systems and a plurality of secondary signals received from the one or more secondary systems;
verifying, at the host processor, the corresponding second record by comparing a primary signal subset from the plurality of primary signals to a secondary signal subset from the plurality of secondary signals, to generate a verified signal when matched;
on receiving a verified signal, segregating, at the host processor, the plurality of primary signals to generate a categorized record including a plurality of data categories, wherein a data category corresponds to a predefined tag;
receiving, at the host processor via the computing network, physical asset signals, associated to the client identifier, from an external asset system;
generating, at the host processor, a qualifier score based on a predictive algorithm applied to the categorized record and the physical asset signals, the predictive algorithm assigning weights to the plurality of data categories in the categorized record; and
determining whether the qualifier score meets a one or more threshold range.

2. The method of claim 1, further comprising:
normalizing, at the host processor, the plurality of data categories based on a sufficiency factor, wherein the sufficiency factor provides completeness check on the plurality of data categories by comparing the plurality of data categories to a plurality of weighted fields to determine a missing data value;
on determining the missing data value, when a corresponding data value is available in the plurality of secondary signals, entering the corresponding data value from the plurality of secondary signals to the missing data value in the plurality of data categories; and
on determining the missing data value, when the corresponding data value is unavailable in the plurality of secondary signals, entering a null value to the missing data value in the plurality of data categories.

3. The method of claim 1, wherein the plurality of external systems includes: employment data server, financial institution server, credit reporting server, estate servers, criminal records server, and client data servers.

4. The method of claim 1, wherein the implementing of the predefined tags comprises:
scanning, by the host processor, the input signals to extract an identified information matching the predefined tags; and
storing the identified information in the corresponding second record.

5. The method of claim 1, wherein the predefined tags include: an asset tag, a liability tag, and a transactions tag.

6. The method of claim 1, wherein the plurality of data categories include: an asset category, a liability category, and an income category.

7. The method of claim 1, wherein the physical asset signals include any one or more of a location data, an asset market value, a transaction date, and a rental value.

8. The method of claim 1, wherein the plurality of input signals is received from a plurality of external systems by a secure application programming interface (API).

9. The method of claim 1, wherein the plurality of input signals is received as a JSON file.

10. A score estimation device for connected to a computing network, comprising:
a signal reception module, configured to receive, by the computing network, a plurality of input signals from a plurality of external systems, the input signals corresponding to a client identifier to generate a corresponding first record, and the external systems including primary systems and one or more secondary systems;
a data extraction module, configured to extract a corresponding second record by implementing a plurality of predefined tags, the corresponding second record including a plurality of primary signals received from the primary systems and a plurality of secondary signals received from the one or more secondary systems;
a data verification module, configured to verify the corresponding second record by comparing a primary signal subset from the plurality of primary signals to a secondary signal subset from the plurality of secondary signals, to generate a verified signal when matched;
a data segregation module, configured to, on receiving the verified signal, segregate the plurality of primary signals to generate a categorized record including a plurality of data categories, wherein a data category corresponds to a predefined tag;
the signal reception module, configured to receive, by the computing network, physical asset signals, associated to the client identifier, from an external asset system;
a score calculation module, configured to generate, a qualifier score based on a predictive algorithm applied to the categorized record and the physical asset signals, the predictive algorithm assigning weights to the plurality of data categories in the categorized record; and
a threshold determination module, configured to determine whether the qualifier score meets a one or more threshold range.

11. The device of claim 10, further comprising: a normalization module, configured to:
normalize, at the host processor, the plurality of data categories based on a sufficiency factor, wherein the sufficiency factor provides completeness check on the plurality of data categories by comparing the plurality of data categories to a plurality of weighted fields to determine a missing data value;
on determining the missing data value, when a corresponding data value is available in the plurality of secondary signals, entering the corresponding data value from the plurality of secondary signals to the missing data value in the plurality of data categories; and
on determining the missing data value, when the corresponding data value is unavailable in the plurality of secondary signals, entering a null value to the missing data value in the plurality of data categories.

12. The device of claim 10, wherein the plurality of external systems includes: employment data server, financial institution server, credit reporting server, estate servers, criminal records server, and client data servers.

13. The device of claim 10, wherein the data extraction module is configured to:
scan the input signals to extract an identified information matching the predefined tags; and
store the identified information in the corresponding second record.

14. The device of claim 10, wherein the predefined tags include: an asset tag, a liability tag, and an income tag.

15. The device of claim 10, wherein the plurality of data categories includes: an asset category, a liability category, and an income category.

16. The device of claim 10, wherein the physical asset signals include any one or more of a location data, an asset market value, transaction date, and a rental value.

17. The device of claim 10, wherein the plurality of input signals is received from a plurality of external systems by a secure application programming interface (API).

18. The device of claim 10, wherein the plurality of input signals is received as a JSON file.

19. A computer-readable storage medium, storing computer-executable instructions thereon, when executed by a computer, the computer is configured to:
receive, at the host processor via the computing network, a plurality of input signals from a plurality of external systems, the input signals corresponding to a client identifier to generate a corresponding first record, and the external systems including primary systems and one or more secondary systems;
analyze, at the host processor, the corresponding first record, to extract a corresponding second record by implementing a plurality of predefined tags, the corresponding second record including a plurality of primary signals received from the primary systems and a plurality of secondary signals received from the one or more secondary systems;
verify, at the host processor, the corresponding second record by comparing a primary signal subset from the plurality of primary signals to a secondary signal subset from the plurality of secondary signals, to generate a verified signal when matched;
on receiving a verified signal, segregate, at the host processor, the plurality of primary signals to generate a categorized record including a plurality of data categories, wherein a data category corresponds to a predefined tag;
receive, at the host processor, physical asset signals, associated to the client identifier, from an external asset system;
generate, at the host processor, a qualifier score based on a predictive algorithm applied to the categorized record and the physical asset signals, the predictive algorithm assigning weights to the plurality of data categories in the categorized record; and
determine whether the qualifier score meets a one or more threshold range.

20. The storage medium of claim 19, wherein the computer is further configured to:
normalize, at the host processor, the plurality of data categories based on a sufficiency factor, wherein the sufficiency factor provides completeness check on the plurality of data categories by comparing the plurality of data categories to a plurality of weighted fields to determine a missing data value;
on determining the missing data value, when a corresponding data value is available in the plurality of secondary signals, entering the corresponding data value from the plurality of secondary signals to the missing data value in the plurality of data categories; and
on determining the missing data value, when the corresponding data value is unavailable in the plurality of secondary signals, entering a null value to the missing data value in the plurality of data categories.
